(19) United States
(12) Patent Application Publication
(10) Pub. No.: US 2025/0044508 A1
(43) Pub. Date: Feb. 6, 2025

(54) PHASE ADJUSTER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi, (JP)

(72) Inventors: Tatsuya KAMIYA, Nisshin-shi (JP); Yuki KAMATA, Nisshin-shi (JP); Toshihiro ODA, Nisshin-shi (JP)

(21) Appl. No.: 18/668,813

(22) Filed: May 20, 2024

(30) Foreign Application Priority Data
Aug. 2, 2023 (JP) 2023-126462

(51) Int. Cl. G02B 6/122

(52) U.S. Cl. CPC G02B 6/1228

(57) ABSTRACT

A phase adjuster includes: a first optical path extending along a predetermined direction to propagate a first light; and a second optical path extending along the predetermined direction to propagate a second light different from the first light. The first optical path and the second optical path oppose to each other. A portion of the first optical path and a portion of the second optical path are formed of members having different light refractive indexes.

### CROSS REFERENCE TO RELATED APPLICATION

This application is based on Japanese Patent Application No. 2023-126462 filed on Aug. 2, 2023, the disclosure of which is incorporated herein by reference.

### TECHNICAL FIELD

The present disclosure relates to a phase adjuster.

### BACKGROUND

A passive phase adjuster adjusts phases of two incident lights by changing shapes of two waveguides through which the two incident lights are respectively propagated (for example, refer to Ultra-Broadband Mode Converter and Multiplexer Based on Sub-Wavelength Structures Volume 10, Number 2, April 2018).

### SUMMARY

According to an aspect of the present disclosure, a phase adjuster includes: a first optical path extending along a predetermined direction to propagate a first light; and a second optical path opposing the first optical path and extending along the predetermined direction to propagate a second light different from the first light. A portion of the first optical path and a portion of the second optical path are formed of members having different light refractive indexes.

### BRIEF DESCRIPTION OF DRAWING

FIG. 1 is a diagram illustrating a phase adjuster according to a first embodiment.

FIG. 2 is a top view of the phase adjuster according to the first embodiment.

FIG. 3 is a cross-sectional view taken along line III-III shown in FIG. 2.

FIG. 4 is a diagram showing a difference in effective refractive index of light between a core layer formed of silicon nitride and a core layer formed of silicon.

FIG. 5 is a diagram for explaining change in phase of light propagating on an optical path.

FIG. 6 is a diagram for explaining change in phase of light propagating on an optical path.

FIG. 7 is a diagram for explaining a phase difference of lights propagating through two optical paths respectively.

FIG. 8 is a top view of a comparison phase adjuster.

FIG. 9 is a diagram showing a relationship between a rate of increase in a core width and a rate of increase in an effective refractive index of light.

FIG. 10 is a diagram schematically showing a phase adjuster to provide a phase difference to lights using two optical paths including members having different effective refractive indexes.

FIG. 11 is a diagram showing a first optical path and a second optical path according to the first embodiment.

FIG. 12 is a diagram showing a difference in effective refractive index between two core layers formed of different materials.

FIG. 13 is a diagram illustrating a table summarizing core materials and sizes of phase adjustment portions of the first embodiment and the comparison phase adjuster.

FIG. 14 is a diagram showing a relationship between a deviation in core width and an error in phase difference.

FIG. 15 is a top view of a phase adjuster according to a first modification of the first embodiment.

FIG. 16 is a top view of a phase adjuster according to a second modification of the first embodiment.

FIG. 17 is a top view of a phase adjuster according to a third modification of the first embodiment.

FIG. 18 is a top view of a phase adjuster according to a fourth modification of the first embodiment.

FIG. 19 is a diagram showing a phase adjuster according to a second embodiment.

FIG. 20 is a top view of a phase adjuster according to a third embodiment.

FIG. 21 is a diagram showing a difference in effective refractive index of light between a core layer formed of silicon nitride and a core layer formed of silicon.

FIG. 22 is a diagram showing a rate of increase in effective refractive index of light with respect to a rate of increase in core width.

### DETAILED DESCRIPTION

A passive phase adjuster adjusts phases of two incident lights by changing shapes of two waveguides through which the two incident lights are propagated. The phase adjuster adjusts a phase difference between the two incident lights propagating through two waveguides respectively.

Light is defined to propagate in a waveguide in a predetermined direction, and a direction intersecting the predetermined direction is defined as a width direction. The phase adjuster has an enlarged portion in which each size of the two waveguides in the width direction gradually increases along the predetermined direction. The size of the enlarged portion in the width direction is larger in the second waveguide than in the first waveguide. The phase adjuster can provide a phase difference between the light propagating through the first waveguide and the light propagating through the second waveguide, due to the difference in effective refractive index of the two waveguides, which is caused by the difference in the size between the enlarged portions of the two waveguides.

When the two waveguides have the same length in the predetermined direction, the phase difference that can be imparted to lights propagating through the two waveguides is obtained by multiplying the difference in effective refractive indexes of the two waveguides by the length of the waveguide in the predetermined direction. Therefore, the larger the difference in effective refractive index between the two waveguides, the larger the phase difference imparted to the lights propagating through the two waveguides. The effective refractive index can be increased as the size of the waveguide in the width direction is increased.

However, the rate of increase in the effective refractive index relative to the rate of increase in the size of the waveguide in the width direction becomes smaller as the size of the waveguide in the width direction increases. That is, the increase in the effective refractive index with respect to the increase in the width of the waveguide becomes slower as the width of the waveguide becomes larger. Therefore, when a difference in effective refractive index is created between the two waveguides due to a difference in the widthwise size of the enlarged portion between the two waveguides, it is difficult to increase the difference in effective refractive index between the two waveguides.

Therefore, when a phase difference is imparted to lights propagating through two waveguides by the difference in the widthwise size of the enlarged portion between the two waveguides, it is necessary to increase each length of the waveguide in the predetermined direction, as the phase difference to be imparted is larger. However, the length of the phase adjuster is increased in the predetermined direction by increasing the length of the waveguide in the predetermined direction, which is not preferable. Such an issue is discovered through intensive studies by the inventors.

The present disclosure provides a phase adjuster that can impart a phase difference to lights propagating through plural waveguides while suppressing increase in each size of the plural waveguides in a predetermined direction.

According to an aspect of the present disclosure, a phase adjuster includes: a first optical path extending along a predetermined direction to propagate a first light; and a second optical path extending along the predetermined direction and opposing the first optical path to propagate a second light different from the first light. The first optical path and the second optical path have portions formed of members having different light refractive indexes.

Accordingly, a phase difference can be imparted between the first light propagating in the first optical path and the second light propagating in the second optical path by the members having different light refractive indexes. For this reason, it is easy to suppress increase in each size of the first optical path and the second optical path in the predetermined direction, compared to a case where a phase difference is provided between the first light propagating in the first optical path and the second light propagating in the second optical path due to the difference in shape between the first optical path and the second optical path. Thus, a phase difference is created between the first light propagating in the first optical path and the second light propagating in the second optical path, while suppressing increase in each size of the first optical path and the second optical path in the predetermined direction.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The respective embodiments described herein may be partially combined with each other as long as no particular problems are caused even without explicit statement of these combinations.

### First Embodiment

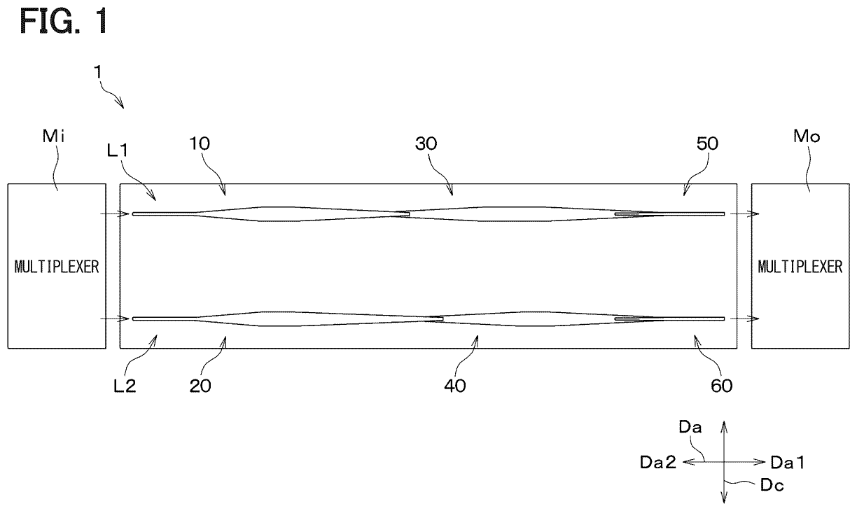

A phase adjuster 1 of this embodiment will be explained with reference to FIGS. 1 to 14. The phase adjuster 1 of this embodiment is arranged, for example, between an input side multiplexer Mi and an output side multiplexer Mo. The phase adjuster 1 adjusts phases of two lights incident on the phase adjuster 1 from the input side multiplexer Mi, and outputs the two adjusted lights to the output side multiplexer Mo. For example, the phase adjuster 1 outputs the lights shifted from each other to the output side multiplexer Mo when the phases of two lights input from the input side multiplexer Mi are aligned. Alternatively, when the phases of two lights input from the input side multiplexer Mi are shifted from each other, the phase adjuster 1 may adjust lights whose phases are aligned to each other and output the adjusted lights to the output side multiplexer Mo.

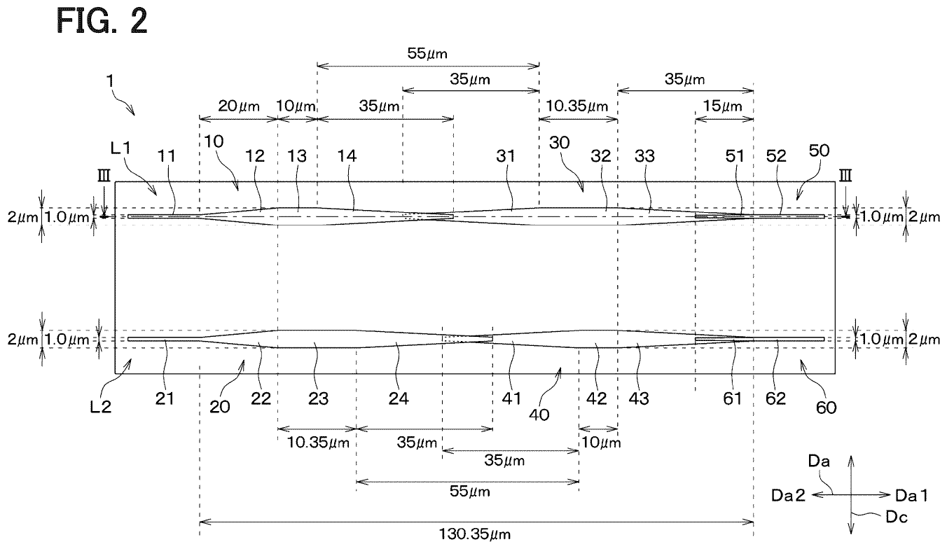

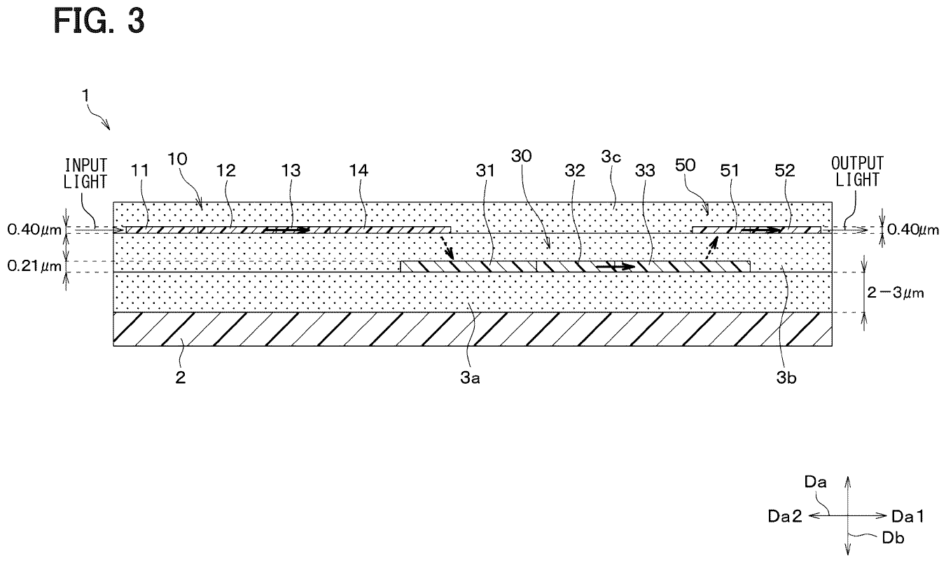

As shown in FIGS. 2 and 3, the phase adjuster 1 of this embodiment includes a silicon substrate 2, three cladding layers 3a, 3b, 3c and six core layers 10, 20, 30, 40, 50, 60. The cladding layers 3a, 3b, 3c and the core layers 10, 20, 30, 40, 50, 60 are stacked on the silicon substrate 2. Specifically, the phase adjuster 1 includes the first cladding layer 3a formed on the silicon substrate 2. The second cladding layer 3b, the third core layer 30, and the fourth core layer 40 are formed on the first cladding layer 3a. The phase adjuster 1 includes the first core layer 10, the second core layer 20, the fifth core layer 50, and the sixth core layer 60, which are formed on the second cladding layer 3b. Hereinafter, the first cladding layer 3a, the second cladding layer 3b, and the third cladding layer 3c may be referred to as the first to third cladding layers 3a-3c. Further, the first core layer 10, the second core layer 20, the third core layer 30, the fourth core layer 40, the fifth core layer 50, and the sixth core layer 60 may be referred to as the first to sixth core layers 10-60. Further, in FIGS. 1 and 2, the second cladding layer 3b and the third cladding layer 3c are omitted.

The first core layer 10 to the sixth core layer 60 have a higher refractive index than the first cladding layer 3a to the third cladding layer 3c. Therefore, the first to sixth core layers 10 to 60 function as waveguide to guide the two lights incident from the input side multiplexer Mi to the output side multiplexer Mo in the phase adjuster 1.

Hereinafter, as shown in FIG. 1 and the like, a direction along which two lights are propagated within the phase adjuster 1 will be referred to as a first direction Da. Further, in the first direction Da, the phase adjuster 1 emits light in an emission direction Da1, and a direction opposite to the emission direction Da1 is a reverse direction Da2.

As shown in FIG. 3 and the like, the first cladding layer 3a to the third cladding layer 3c are stacked in a second direction Db, and a direction perpendicular to the first direction Da and the second direction Db is a third direction Dc.

As shown in FIGS. 2 and 3, the first cladding layer 3a is formed in a cubic shape whose longitudinal direction is the first direction Da. The second cladding layer 3b, the third core layer 30, and the fourth core layer 40 are formed on the first cladding layer 3a. The second cladding layer 3b is formed on the first cladding layer 3a in a region other than the region where the third core layer 30 and the fourth core layer 40 are formed. Furthermore, the first core layer 10, the second core layer 20, the fifth core layer 50, and the sixth core layer 60 are formed on the second cladding layer 3b. The third cladding layer 3c is formed on the second cladding layer 3b, excluding the region where the first core layer 10, the second core layer 20, the fifth core layer 50, and the sixth core layer 60 are formed.

The first cladding layer 3a, the second cladding layer 3b, and the third cladding layer 3c are made of, for example, silicon oxide (SiO₂), which is an insulator.

The first core layer 10, the second core layer 20, the fifth core layer 50, and the sixth core layer 60 are formed on the second cladding layer 3b. The third core layer 30 and the fourth core layer 40 are formed on the first cladding layer 3a. The first core layer 10 to the sixth core layer 60 are formed into a flat thin plate shape whose size in the second direction Db is smaller than the size in the first direction Da and the third direction Dc. That is, the first core layer 10 to the sixth core layer 60 are formed as strip-type waveguides. The first core layer 10 to the sixth core layer 60 of this embodiment are significantly smaller in size in the second direction Db than in the first direction Da and third direction Dc. Hereinafter, each size of the first core layer 10 to the sixth core layer 60 in the first direction Da is referred to as a core length. Each size of the first core layer 10 to the sixth core layer 60 in the second direction Db is referred to as a core thickness. Each size of the first core layer 10 to the sixth core layer 60 in the third direction Dc may be referred to as a core width.

As shown in FIG. 2, the first core layer 10, the third core layer 30, and the fifth core layer 50 are formed at the same position in the third direction Dc. The first core layer 10, the third core layer 30, and the fifth core layer 50 are arranged in this order along the emission direction Da1. However, as shown in FIG. 3, the positions of the first core layer 10 and the fifth core layer 50 are shifted from the third core layer 30 in the second direction Db.

As shown in FIG. 2, the second core layer 20, the fourth core layer 40, and the sixth core layer 60 are aligned in position in the third direction Dc. The second core layer 20, the fourth core layer 40, and the sixth core layer 60 are arranged in this order along the emission direction Da1. However, although not shown, the positions of the second core layer 20 and the sixth core layer 60 are shifted from the fourth core layer 40 in the second direction Db.

Further, the first core layer 10, the third core layer 30, and the fifth core layer 50 respectively oppose to the second core layer 20, the fourth core layer 40, and the sixth core layer 60 in the third direction Dc through a clearance. Specifically, the first core layer 10 faces the second core layer 20 in the third direction Dc. The third core layer 30 faces the fourth core layer 40 in the third direction Dc. The fifth core layer 50 faces the sixth core layer 60 in the third direction Dc. The third direction Dc of this embodiment corresponds to an opposing direction.

The first core layer 10, the third core layer 30, and the fifth core layer 50 formed in this way function as the first optical path L1 through which the first light, which is one of the two lights incident from the input side multiplexer Mi, is propagated. Further, the second core layer 20, the fourth core layer 40, and the sixth core layer 60 function as the second optical path L2 through which the second light, which is the other of the two lights incident from the input side multiplexer Mi, is propagated. The first optical path L1 constituted by the first core layer 10, the third core layer 30, and the fifth core layer 50, and the second optical path L2 constituted by the second core layer 20, the fourth core layer 40, and the sixth core layer 60 are formed to extend along the first direction Da, which is a predetermined direction. The first optical path L1 and the second optical path L2 have portions formed of members whose light refractive indexes are different from each other.

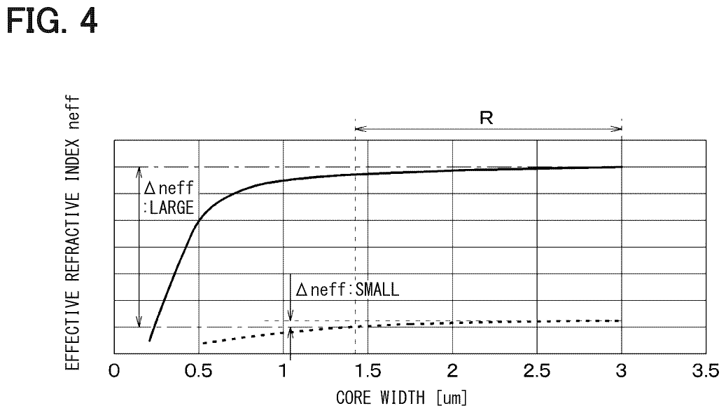

Specifically, the first core layer 10, the second core layer 20, the fifth core layer 50, and the sixth core layer 60 are made of silicon nitride (SIN). The third core layer 30 and the fourth core layer 40 are made of silicon (Si), which has a different optical refractive index from silicon nitride. As shown in FIG. 4, silicon nitride and silicon have different effective refractive indexes for light. Specifically, silicon has a larger effective refractive index than silicon nitride under the same core width conditions. In FIG. 4, the solid line indicates the effective refractive index of silicon for light, and the broken line indicates the effective refractive index of silicon nitride for light.

That is, the first optical path L1 includes the first core layer 10, the fifth core layer 50, and the third core layer 30 formed of a member having different optical refractive index from the first core layer 10 and the fifth core layer 50. The second optical path L2 includes the second core layer 20, the sixth core layer 60, and the fourth core layer 40 formed of a member having different refractive index from the second core layer 20 and the sixth core layer 60. The first core layer 10, the second core layer 20, the fifth core layer 50, and the sixth core layer 60 are made of the same material, that is silicon nitride. Further, the second core layer 20 and the fourth core layer 40 are made of the same material, that is silicon.

The first core layer 10, the third core layer 30, and the fifth core layer 50 that constitute the first optical path L1 will be explained.

As shown in FIG. 2, the first core layer 10 includes a first incidence portion 11, a first enlarged portion 12, a first propagation portion 13, and a first reduction portion 14. The first incidence portion 11, the first enlarged portion 12, the first propagation portion 13, and the first reduction portion 14 are formed in succession in this order along the emission direction Da1. The first core layer 10 has a core thickness of 0.40 μm, which is constant from the end in the reverse direction Da2 to the end in the emission direction Da1. The first core layer 10 has different core widths depending on the first incidence portion 11, the first enlarged portion 12, the first propagation portion 13, and the first reduction portion 14.

The first incidence portion 11 is optically coupled to the input side multiplexer Mi, and guides the first light propagated from the input side multiplexer Mi in the emission direction Da1. The first incidence portion 11 has a core width that is constant from the end in the reverse direction Da2 to the end in the emission direction Da1. Specifically, the first incidence portion 11 has a core width of 1.0 μm. In this embodiment, the first incidence portion 11 corresponds to a first input portion.

The first enlarged portion 12 propagates the first light from the first incidence portion 11. The core width of the first enlarged portion 12 gradually increases along the emission direction Da1 from the end in the reverse direction Da2 to the end in the emission direction Da1. Specifically, the core width of the first enlarged portion 12 is 1.0 μm at the end in the reverse direction Da2, and increases to 2.0 μm at the end in the emission direction Da1. Further, the first enlarged portion 12 is formed with a core length of 20 μm.

The first propagation portion 13 propagates the first light from the first enlarged portion 12, and guides the first light propagated from the first enlarged portion 12 in the emission direction Da1. The first propagation portion 13 has a core width that is constant from the end in the reverse direction Da2 to the end in the emission direction Da1, and has a size that allows the first light to propagate in a higher order mode. Specifically, as shown in FIG. 4, the first propagation portion 13 made of silicon nitride has the core width of 2.0 μm within the slowing region R where the rate of increase in the effective refractive index of light can be made significantly smaller relative to the rate of increase in the core width. Further, the first propagation portion 13 is formed with a core length of 10 μm.

The first reduction portion 14 optically couples the first core layer 10 to the third core layer 30 and transfers the first light propagated to the first propagation portion 13 to the third core layer 30. The first reduction portion 14 has the core width gradually becoming smaller along the emission direction Da1 from the end in the reverse direction Da2 to the end in the emission direction Da1. Specifically, the core width of the first reduction portion 14 is 2.0 μm at the end in the reverse direction Da2. Although not shown, the core width of the first reduction portion 14 is 0.15 μm at the end in the emission direction Da1. The core width of the first reduction portion 14 at the end in the emission direction Da1 is as small as possible by the manufacturing process used. Further, the first reduction portion 14 is formed with a core length of 35 μm.

A part of the first reduction portion 14 in the emission direction Da1 overlaps with a third enlarged portion 31, which will be described later, of the third core layer 30 in the second direction Db.

The third core layer 30 is formed apart from the first core layer 10 and the fifth core layer 50 in the second direction Db. The third core layer 30 includes the third enlarged portion 31, a third propagation portion 32, and a third reduction portion 33. The third enlarged portion 31, the third propagation portion 32, and the third reduction portion 33 are formed in succession in this order along the emission direction Da1. The third core layer 30 has a core thickness of 0.21 μm from the end in the reverse direction Da2 to the end in the emission direction Da1. The third core layer 30 has different core widths depending on the third enlarged portion 31, the third propagation portion 32, and the third reduction portion 33.

The third enlarged portion 31 is optically coupled to the first reduction portion 14 and guides the first light propagated from the first reduction portion 14 in the emission direction Da1. The third enlarged portion 31 has the core width gradually increasing along the emission direction Da1 from the end in the reverse direction Da2 to the end in the emission direction Da1. Specifically, although not shown, the core width of the third enlarged portion 31 is 0.15 μm at the end in the reverse direction Da2, and increases to 2.0 μm at the end in the emission direction Da1. The core width of the third enlarged portion 31 at the end in the reverse direction Da2 is as small as possible by the manufacturing process used. Further, the third enlarged portion 31 is formed with a core length of 35 μm.

The third propagation portion 32 propagates the first light from the third enlarged portion 31, and guides the first light propagated from the third enlarged portion 31 in the emission direction Da1. The third propagation portion 32 has a core width that is constant from the end in the reverse direction Da2 to the end in the emission direction Da1, and has a size that allows the first light to propagate in a higher order mode. Specifically, as shown in FIG. 4, the third propagation section 32 made of silicon has a core width of 2.0 μm within the slowing region R where the rate of increase in the effective refractive index of light can be made significantly smaller relative to the rate of increase in the core width. The third propagation portion 32 has a core width equal to the core width of the first propagation portion 13.

“The core width of the third propagation portion 32 is equal to the core width of the first propagation portion 13” does not strictly mean that the core width of the third propagation portion 32 and the core width of the first propagation portion 13 completely match, but includes slight deviations in size due to manufacturing errors. Such a description of “equal” has the same meaning in the description of the shape of each component of the phase adjuster 1, which will be described later.

The third propagation portion 32 has a core length larger than the core length of the first propagation portion 13. Specifically, the third propagation portion 32 has a core length of 10.35 μm longer than the core length of the first propagation portion 13 by 0.35 μm. In FIG. 2, in order to make it easy to understand the difference between the core length of the first propagation portion 13 and the core length of the third propagation portion 32, the difference of 0.35 μm is exaggerated.

The third reduction portion 33 optically couples the third core layer 30 to the fifth core layer 50 and transfers the first light propagated from the third propagation portion 32 to the fifth core layer 50. The third reduction portion 33 has the core width gradually becoming smaller along the emission direction Da1 from the end in the reverse direction Da2 to the end in the emission direction Da1. Specifically, the core width of the third reduction portion 33 is 2.0 μm at the end in the reverse direction Da2. Although not shown, the core width of the third reduction portion 33 is 0.15 μm at the end in the emission direction Da1. The core width of the third reduction portion 33 at the end in the emission direction Da1 is as small as possible by the manufacturing process used. Further, the third reduction portion 33 is formed with a core length of 35 μm.

Further, a part of the third reduction portion 33 in the emission direction Da1 is formed to overlap with a fifth enlarged portion 51 of the fifth core layer 50 in the second direction Db.

The fifth core layer 50 includes a fifth enlarged portion 51 and a fifth emission portion 52. The fifth enlarged portion 51 and the fifth emission portion 52 are formed in series in this order along the emission direction Da1. The fifth core layer 50 has a core thickness of 0.40 μm which is constant from the end in the reverse direction Da2 to the end in the emission direction Da1. The fifth core layer 50 has different core widths depending on the fifth enlarged portion 51 and the fifth emission portion 52.

The fifth enlarged portion 51 is optically coupled to the third reduction portion 33 and guides the first light propagated from the third reduction portion 33 in the emission direction Da1. The fifth enlarged portion 51 has the core width gradually increasing along the emission direction Da1 from the end in the reverse direction Da2 to the end in the emission direction Da1. Specifically, although not shown, the core width of the fifth enlarged portion 51 is 0.15 μm at the end in the reverse direction Da2, and increases to 1.0 μm at the end in the emission direction Da1. The core width of the fifth enlarged portion 51 at the end in the reverse direction Da2 as small as possible by the manufacturing process used. Further, the fifth enlarged portion 51 is formed with a core length of 15 μm.

The fifth emission portion 52 propagates the first light from the fifth enlarged portion 51, and guides the first light propagated from the fifth enlarged portion 51 to the output side multiplexer Mo. The end of the fifth emission portion 52 in the emission direction Da1 is optically coupled to the output side multiplexer Mo. The fifth emission portion 52 has a constant core width from the end in the reverse direction Da2 to the end in the emission direction Da1, and is formed smaller than the first propagation portion 13 and the third propagation portion 32. Specifically, the fifth emission portion 52 is formed with a core width of 1.0 μm. The fifth emission portion 52 has the same core width as the first incidence portion 11. In this embodiment, the fifth emission portion 52 corresponds to a first output portion.

The above is a description of the first core layer 10, the third core layer 30, and the fifth core layer 50 that constitute the first optical path L1. Next, the second core layer 20, the fourth core layer 40, and the sixth core layer 60 that constitute the second optical path L2 will be explained.

The second core layer 20 includes a second incidence portion 21, a second enlarged portion 22, a second propagation portion 23, and a second reduction portion 24. The second incidence portion 21, the second enlarged portion 22, the second propagation portion 23, and the second reduction portion 24 are formed in succession in this order along the emission direction Da1. The second core layer 20 has a core thickness of 0.40 μm, which is constant, from the end in the reverse direction Da2 to the end in the emission direction Da1. The second core layer 20 has different core widths depending on the second incidence portion 21, the second enlarged portion 22, the second propagation portion 23, and the second reduction portion 24.

Further, the second core layer 20 is similar in shape to the first core layer 10. Specifically, in the second core layer 20, the second incidence portion 21 is formed in the same shape as the first incidence portion 11, the second enlarged portion 22 is formed in the same shape as the first enlarged portion 12, and the second reduction portion 24 is formed in the same shape as the first reduction portion 14. In the second core layer 20, the second propagation portion 23 is formed in a different shape from the first propagation portion 13. Specifically, the second propagation portion 23 has a different core length from the first propagation portion 13. That is, the first core layer 10 and the second core layer 20 are formed to have the same shape except for the core length of the first propagation portion 13 and the core length of the second propagation portion 23. Therefore, in the following description of the second incidence portion 21, the second enlarged portion 22, the second propagation portion 23, and the second reduction portion 24, description of the sizes will be partially omitted.

The second incidence portion 21 is optically coupled to the input side multiplexer Mi, and guides the second light propagated from the input side multiplexer Mi in the emission direction Da1. The second incidence portion 21 has a core width that is constant from the end in the reverse direction Da2 to the end in the emission direction Da1. In this embodiment, the second incidence portion 21 corresponds to a second input portion.

The second enlarged portion 22 propagates the second light from the second incidence portion 21. In the second enlarged portion 22, the core width gradually increases along the emission direction Da1 from the end in the reverse direction Da2 to the end in the emission direction Da1.

The second propagation portion 23 propagates the second light from the second enlarged portion 22, and guides the second light propagated from the second enlarged portion 22 in the emission direction Da1. The second propagation portion 23 has a core width that is constant from the end in the reverse direction Da2 to the end in the emission direction Da1, and has a size that allows the second light to propagate in a higher order mode. Specifically, as shown in FIG. 4, the second propagation portion 23 formed of silicon nitride has a core width of 2.0 μm within the slowing region R where the rate of increase in the effective refractive index of light is made significantly smaller relative to the rate of increase in the core width.

Further, the second propagation portion 23 has a core length larger than the core length of the first propagation portion 13. Specifically, the second propagation portion 23 has a core length of 10.35 μm that is longer than the core length of the first propagation portion 13 by 0.35 μm. The second propagation portion 23 is formed to have a core length equal to the core length of the third propagation portion 32. In FIG. 2 and the like, in order to make it easier to understand the difference between the core length of the second propagation portion 23 and the core length of the first propagation portion 13, the difference of 0.35 μm is exaggerated.

The second reduction portion 24 optically couples the second core layer 20 to the fourth core layer 40 and transfers the second light propagated to the second propagation portion 23 to the fourth core layer 40. The second reduction portion 24 has the core width, which gradually becomes smaller along the emission direction Da1 from the end in the reverse direction Da2 to the end in the emission direction Da1. Further, the second reduction portion 24 has an end part that overlaps the fourth enlarged portion 41 of the fourth core layer 40 in the emission direction Da1, which will be described later, in the second direction Db.

The fourth core layer 40 includes a fourth enlarged portion 41, a fourth propagation portion 42, and a fourth reduction portion 43. The fourth enlarged portion 41, the fourth propagation portion 42, and the fourth reduction portion 43 are formed in succession in this order along the emission direction Da1. The fourth core layer 40 has a core thickness of 0.21 μm, which is constant from the end in the reverse direction Da2 to the end in the emission direction Da1. The fourth core layer 40 has different core widths depending on the fourth enlarged portion 41, the fourth propagation portion 42, and the fourth reduction portion 43.

Further, the fourth core layer 40 is similar in shape to the third core layer 30. Specifically, in the fourth core layer 40, the fourth enlarged portion 41 is formed in the same shape as the third enlarged portion 31, and the fourth reduction portion 43 is formed in the same shape as the third reduction portion 33. In the fourth core layer 40, the fourth propagation portion 42 is formed in a shape different from that of the third propagation portion 32. Specifically, the fourth propagation portion 42 has a different core length from the third propagation portion 32. That is, the third core layer 30 and the fourth core layer 40 are formed to have the same shape except for the core length of the third propagation portion 32 and the core length of the fourth propagation portion 42. Therefore, in the following description of the fourth enlarged portion 41, the fourth propagation portion 42, and the fourth reduction portion 43, description of the sizes will be partially omitted.

The fourth enlarged portion 41 is optically coupled to the second reduction portion 24 and guides the second light propagated from the second reduction portion 24 in the emission direction Da1. In the fourth enlarged portion 41, the core width gradually increases along the emission direction Da1 from the end in the reverse direction Da2 to the end in the emission direction Da1.

The fourth propagation portion 42 propagates the first light from the fourth enlarged portion 41, and guides the first light propagated from the fourth enlarged portion 41 in the emission direction Da1. The fourth propagation portion 42 has a core width that is constant from the end in the reverse direction Da2 to the end in the emission direction Da1, and has a size that allows the first light to propagate in a higher order mode. Specifically, as shown in FIG. 4, the fourth propagation portion 42 made of silicon has a core width of 2.0 μm within the slowing region R to allow the rate of increase in the effective refractive index of light to be significantly smaller than the rate of increase in the core width.

Further, the core length of the fourth propagation portion 42 is smaller than the core length of the second propagation portion 23. Specifically, the fourth propagation portion 42 has a core length of 10 μm which is smaller than the core length of the second propagation portion 23 by 0.35 μm. The fourth propagation portion 42 is formed to have a core length equal to the core length of the first propagation portion 13.

The fourth reduction portion 43 optically couples the fourth core layer 40 to the sixth core layer 60 and transfers the second light propagated from the fourth propagation portion 42 to the sixth core layer 60. The fourth reduction portion 43 has the core width, which gradually becomes smaller along the emission direction Da1 from the end in the reverse direction Da2 to the end in the emission direction Da1. Further, the fourth reduction portion 43 has an end part in the emission direction Da1, which overlaps a sixth enlarged portion 61 of the sixth core layer 60 in the second direction Db.

The sixth core layer 60 includes a sixth enlarged portion 61 and a sixth emission portion 62. The sixth enlarged portion 61 and the sixth emission portion 62 are formed in series in this order along the emission direction Da1. The sixth core layer 60 has a core thickness of 0.40 μm which is constant from the end in the reverse direction Da2 to the end in the emission direction Da1. The sixth core layer 60 has different core widths depending on the sixth enlarged portion 61 and the sixth emission portion 62.

The sixth enlarged portion 61 is optically coupled to the fourth reduction portion 43 and guides the second light propagated from the fourth reduction portion 43 in the emission direction Da1. The sixth enlarged portion 61 has the core width, which gradually increases along the emission direction Da1 from the end in the reverse direction Da2 to the end in the emission direction Da1.

The sixth emission portion 62 propagates the second light from the sixth enlarged portion 61, and guides the second light propagated from the sixth enlarged portion 61 to the output side multiplexer Mo. The end of the sixth emission portion 62 in the emission direction Da1 is optically coupled to the output side multiplexer Mo. The sixth emission portion 62 has a constant core width from the end in the reverse direction Da2 to the end in the emission direction Da1, and is formed smaller than the second propagation portion 23 and the fourth propagation portion 42. In this embodiment, the sixth emission portion 62 corresponds to a second output portion.

When the first core layer 10, the second core layer 20, the third core layer 30 and the fourth core layer 40 are formed in this way, the core length of the first core layer 10 is smaller than the third core layer 30 by the difference in core length between the first propagation portion 13 and the third propagation portion 32. Further, the second core layer 20 has a longer core length than the fourth core layer 40 by the difference in core length between the second propagation portion 23 and the fourth propagation portion 42. The difference in core length between the first propagation portion 13 and the third propagation portion 32 is equal to the difference in core length between the second propagation portion 23 and the fourth propagation portion 42. In other words, the sum of the core length of the first propagation portion 13 and the core length of the third propagation portion 32 is equal to the sum of the core length of the second propagation portion 23 and the core length of the fourth propagation portion 42.

A part of the first optical path L1 different from the first propagation portion 13 and the third propagation portion 32 is made of the same material and has the same shape as a part of the second optical path L2 different from the second propagation portion 23 and the fourth propagation portion 42. The first optical path L1 and the second optical path L2 have the same size in the first direction Da. When a part of the first optical path L1 different from the first propagation portion 13 and the third propagation portion 32 is made of the same material and has the same shape as a part of the second optical path L2 different from the second propagation portion 23 and the fourth propagation portion 42, a length of the first optical path L1 different from the first propagation portion 13 and the third propagation portion 32 in the first direction Da is equal to a length of the second optical path L2 different from the second propagation portion 23 and the fourth propagation portion 42 in the first direction Da.

The first incidence portion 11, the second incidence portion 21, the fifth emission portion 52, and the sixth emission portion 62 are formed of silicon nitride, which is the same material.

The input side multiplexer Mi and the output side multiplexer Mo, to which the phase adjuster 1 of the present embodiment is connected, are formed of silicon nitride, which is the same material as the first incidence portion 11, the second incidence portion 21, the fifth emission portion 52, and the sixth emission portion 62. Therefore, in the phase adjuster 1, the first incidence portion 11 and the second incidence portion 21 can be directly connected to the input side multiplexer Mi, and the fifth emission portion 52 and the sixth emission portion 62 can be directly connected to the output side multiplexer Mo.

In this embodiment, the first propagation portion 13 functions as a first waveguide, and the third propagation portion 32 functions as a third waveguide. Furthermore, the second propagation portion 23 functions as a second waveguide, and the fourth propagation portion 42 functions as a fourth waveguide.

In order to manufacture the phase adjuster 1 of this embodiment, first, a silicon substrate 2 is prepared, and a first cladding layer 3a is formed on the silicon substrate 2. Then, the third core layer 30 and the fourth core layer 40 are formed on the first cladding layer 3a by patterning. After that, a second cladding layer 3b is formed on the third core layer 30, the fourth core layer 40, and the first cladding layer 3a where the third core layer 30 and the fourth core layer 40 are not formed. Thereby, the third core layer 30 and the fourth core layer 40 are covered with the second cladding layer 3b. Then, unnecessary portions of the second cladding layer 3b formed on the third core layer 30 and the fourth core layer 40 are removed by, for example, CMP (Chemical Mechanical Polish).

Thereafter, the first core layer 10, the second core layer 20, the fifth core layer 50, and the sixth core layer 60 are formed on the second cladding layer 3b by patterning. Then, the third cladding layer 3c is formed on the first core layer 10, the second core layer 20, the fifth core layer 50, the sixth core layer 60, and the second cladding layer 3b where the second core layer 10, the second core layer 20, the fifth core layer 50 and the sixth core layer 60 are not formed. Thereby, the first core layer 10, the second core layer 20, the fifth core layer 50, and the sixth core layer 60 are covered with the third cladding layer 3c.

Thereafter, unnecessary portions of the third cladding layer 3c formed on the first core layer 10, the second core layer 20, the fifth core layer 50, and the sixth core layer 60 are removed by, for example, CMP. As a result, the phase adjuster 1 in which the first to third cladding layers 3a to 3c and the first to sixth core layers 10 to 60 are formed on the silicon substrate 2 is manufactured.

Next, the operation of the phase adjuster 1 of this embodiment will be explained. In the phase adjuster 1 of the present embodiment, when the first light is propagated from the input side multiplexer Mi to the first incidence portion 11 of the first core layer 10, the first light is transmitted to the first enlarged portion 12 and the first propagation portion 13 along the emission direction Da1, and is propagated from the first propagation portion 13 to the first reduction portion 14.

The first reduction portion 14 has the core width that is reduced along the emission direction Da1. Therefore, in the first reduction portion 14, the confinement of light, when the laser light is propagated, becomes gradually weaker along the emission direction Da1. Therefore, the first light propagating through the first reduction portion 14 is gradually transferred to the third enlarged portion 31 of the third core layer 30. The first reduction portion 14 and the third enlarged portion 31 function as a converter that transitions the first light from the first core layer 10 to the third core layer 30.

The first light transferred to the third enlarged portion 31 is propagated along the emission direction Da1, and is propagated from the third enlarged portion 31 to the third reduction portion 33 via the third propagation portion 32.

The third reduction portion 33 has the core width that is reduced along the emission direction Da1. Therefore, in the third reduction portion 33, the confinement of light, when the laser light is propagated, becomes gradually weaker along the emission direction Da1. Therefore, the first light propagating through the third reduction portion 33 is gradually transferred to the fifth enlarged portion 51 of the fifth core layer 50. The third reduction portion 33 and the fifth enlarged portion 51 function as a converter that transitions the first light from the third core layer 30 to the fifth core layer 50.

The first light transferred to the fifth enlarged portion 51 is propagated along the emission direction Da1, and is propagated from the fifth enlarged portion 51 to the fifth emission portion 52. The first light propagated to the fifth emission portion 52 propagates along the emission direction Da1, and is propagated to the output side multiplexer Mo.

Further, in the phase adjuster 1, when the second light is propagated from the input side multiplexer Mi to the second incidence portion 21 of the second core layer 20, the second light is transmitted to the second enlarged portion 22 and the second propagation portion 23 along the emission direction Da1, and is propagated from the second propagation portion 23 to the second reduction portion 24.

The second reduction portion 24 has the core width that is reduced along the emission direction Da1. Therefore, in the second reduction portion 24, light confinement, when the laser light is propagated, becomes gradually weaker along the emission direction Da1. Therefore, the second light propagating through the second reduction portion 24 is gradually transferred to the fourth enlarged portion 41 of the fourth core layer 40. The second reduction portion 24 and the fourth enlarged portion 41 function as a converter that transitions the second light from the second core layer 20 to the fourth core layer 40.

The second light transferred to the fourth enlarged portion 41 is propagated along the emission direction Da1, and is propagated from the fourth enlarged portion 41 to the fourth reduction portion 43 via the fourth propagation portion 42.

The fourth reduction portion 43 has the core width that is reduced along the emission direction Da1. Therefore, in the fourth reduction portion 43, light confinement, when the laser light is propagated, becomes gradually weaker along the emission direction Da1. Therefore, the second light propagating through the fourth reduction portion 43 is gradually transferred to the sixth enlarged portion 61 of the sixth core layer 60. The fourth reduction portion 43 and the sixth enlarged portion 61 function as a converter that transitions the second light from the fourth core layer 40 to the sixth core layer 60.

The second light transferred to the sixth enlarged portion 61 is propagated along the emission direction Da1, and is propagated from the sixth enlarged portion 61 to the sixth emission portion 62. The second light propagated to the sixth emission portion 62 propagates along the emission direction Da1, and is propagated to the output side multiplexer Mo.

In this way, the phase adjuster 1 in which the first light propagates through the first optical path L1 and the second light propagates through the second optical path L2 is configured such that the phase of the first light is changed and the phase of the second light is changed while the first light propagates through the first optical path L1 and the second light propagates through the second optical path L2. Therefore, the phase adjuster 1 arbitrarily adjusts the phase of the first light propagating in the first optical path L1 and the phase of the second light propagating in the second optical path L2. Thus, a phase difference can be provided between the first light emitted from the first optical path L1 and the second light emitted from the second optical path L2. In the phase adjuster 1 of this embodiment, when each wavelength of the first light and the second light is 1550 nm, the above configuration can provide a phase difference of 90° between the first light emitted from the first optical path L1 and the second light emitted from the second optical path L2.

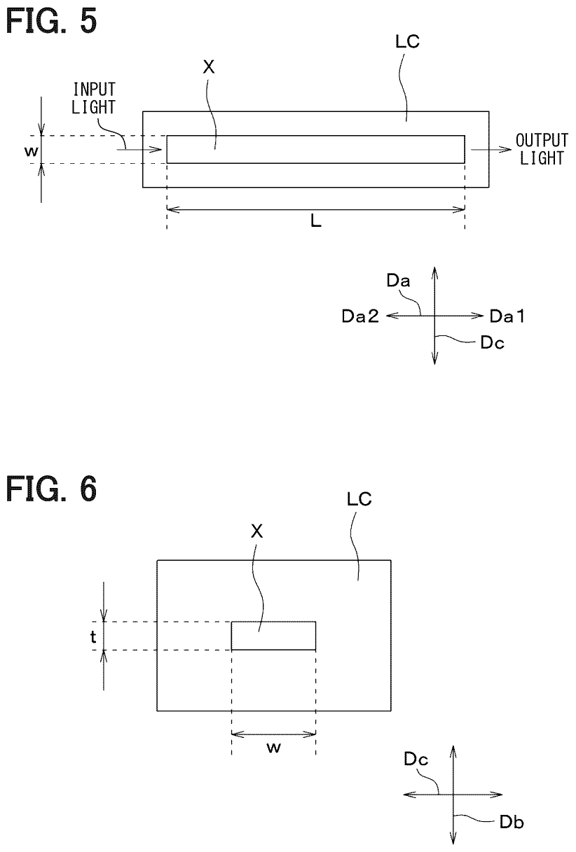

Here, in explaining the change in phase of light propagating through the first optical path L1 and light propagating through the second optical path L2, the change in phase of light will be explained using the optical path X shown in FIGS. 5 and 6. The optical path X shown in FIGS. 5 and 6 has a cladding layer LC whose refractive index is smaller than the refractive index of the optical path X. Then, the propagation constant β of light propagating along the optical path X can be determined using Equation 1.

$$β = k \times {n}_{eff} = 2 π / λ \times {n}_{eff} \qquad ( Equation 1 )$$

Here, k in Equation 1 is the wave number of light. Further, n_{eff} in Equation 1 is the effective refractive index of light on the optical path X. Further, λ in Equation 1 is the wavelength of light.

Then, the change in phase ϕ of light when propagating along the optical path X can be determined by Equation 2 using the propagation constant β.

$$ϕ = β L = 2 π / λ \times {n}_{eff} \times L \qquad ( Equation 2 )$$

Here, L in Equation 2 is the path length of the optical path X, and is equivalent to the length of the phase adjuster 1 of this embodiment in the first direction Da.

As shown in Equation 2, the phase of light rotates by 2π when traveling by a distance of X/n_{eff}. The effective refractive index of light is influenced by the size of the optical path X. Specifically, the effective refractive index of light is determined by the thickness t and the width w of the optical path X. The thickness t is a size in the second direction Db of the phase adjuster 1 of the embodiment. The width is a size in the third direction Dc. Therefore, when there are two optical paths X, the change in phase ¢ of each light when propagating through the optical paths X can be determined using Equation 2.

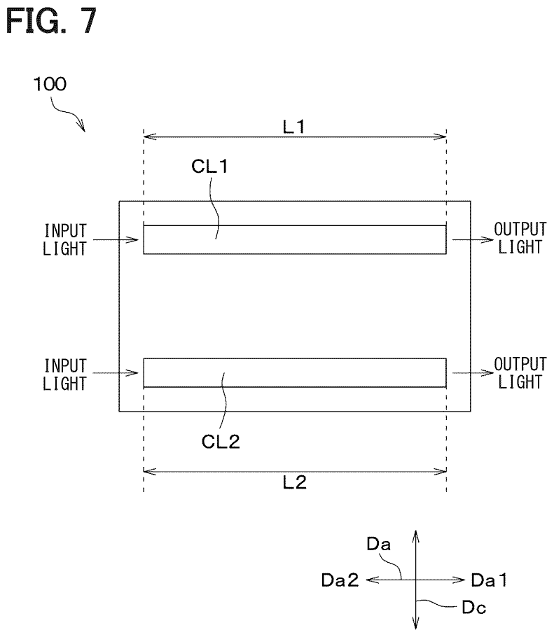

Therefore, the phase difference Δϕ between the light propagating through the first comparison optical path CL1 and the light propagating through the second comparison optical path CL2 shown in FIG. 7 can be calculated using Equation 3. The first comparison optical path CL1 and the second comparison optical path CL2 are formed of the same material and have the same refractive index.

$$Δϕ = 2 π / λ ( ( {n}_{eff 1} \times L 1 ) - ( {n}_{eff 2} \times L 2 ) ) \qquad ( Equation 3 )$$

Here, L1 in Equation 3 is the path length of the first comparison optical path CL1, and corresponds to the length of the phase adjuster 1 of this embodiment in the first direction Da. Further, n_{eff1} in Equation 3 is the effective refractive index of light on the first comparison optical path CL1. Further, L2 in Equation 3 is the path length of the second comparison optical path CL2, and corresponds to the length of the phase adjuster 1 of this embodiment in the first direction Da. Further, n_{eff2} in Equation 3 is the effective refractive index of light on the second comparison optical path CL2.

In this way, a phase difference can be provided between the light emitted from the first comparison optical path CL1 and the light emitted from the second comparison optical path CL2, by utilizing the difference in effective refractive index and the difference in path length between the first comparison optical path CL1 and the second comparison optical path CL2.

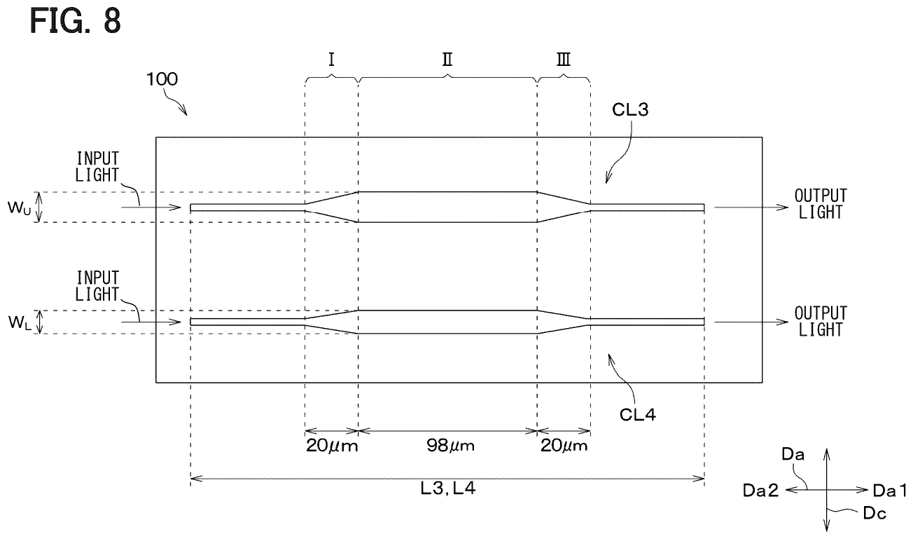

Further, as described above, the effective refractive index of light is influenced by the thickness and the width of each of the first comparison optical path CL1 and the second comparison optical path CL2. Therefore, a comparison phase adjuster 100 having the third comparison optical path CL3 and the fourth comparison optical path CL4 shown in FIG. 8 can provide a phase difference Δϕ between the light propagating through the third comparison optical path CL3 and the light propagating through the fourth comparison optical path CL4 having portions whose width is different from each other.

The third comparison optical path CL3 and the fourth comparison optical path CL4 have the first region I enlarged along the first direction Da, like the first core layer 10 and the second core layer 20, and the third region III that shrinks along the first direction Da. The third comparison optical path CL3 has the second region II whose size in the third direction Dc is expanded to the width Wu, and the path length L3 in the first direction Da. The fourth comparison optical path CL4 has the second region II whose size in the third direction Dc is expanded to the width WL, and the path length L4 in the first direction Da. The third comparison optical path CL3 and the fourth comparison optical path CL4 have equal path lengths. Further, the third comparison optical path CL3 and the fourth comparison optical path CL4 are formed of the same material, that is, have the same refractive index.

Further, the width Wu of the third comparison optical path CL3 is larger than the width WL of the fourth comparison optical path CL4. When the third comparison optical path CL3 and the fourth comparison optical path CL4 are configured in this way, the phase difference Δϕ imparted between the light propagating through the third comparison optical path CL3 and the light propagating through the fourth comparison optical path CL4 can be obtained using Equation 4.

$$Δϕ = ( {ϕ}_{I \_ 3} - {ϕ}_{I \_ 4} ) + ( {ϕ}_{II \_ 3} - {ϕ}_{II \_ 4} ) + ( {ϕ}_{III \_ 3} - {ϕ}_{III \_ 4} ) \qquad ( Equation 4 )$$

Here, (ϕ_{I_3}-ϕ_{I-4}) in Equation 4 represents the phase difference given between the light propagating through the third comparison optical path CL3 and the light propagating through the fourth comparison optical path CL4 in the first region I of the third comparison optical path CL3 and the fourth comparison optical path CL4. In addition, (ϕ_{II_3}-ϕ_{II_4}) in Equation 4 represents the phase difference given between the light propagating through the third comparison optical path CL3 and the light propagating through the fourth comparison optical path CL4 in the second region II of the third comparison optical path CL3 and the fourth comparison optical path CL4. Then, (ϕ_{III_3}-ϕ_{III_4}) in Equation 4 represents the phase difference given between the light propagating through the third comparison optical path CL3 and the light propagating through the fourth comparison optical path CL4 in the third region III of the third comparison optical path CL3 and the fourth comparison optical path CL4.

Further, the third comparison optical path CL3 and the fourth comparison optical path CL4 are configured to have the widthwise size different among the first region I, the second region II, and the third region III of the third comparison optical path CL3 and the fourth comparison optical path CL4. Therefore, in each of the first region I, the second region II, and the third region III, the third comparison optical path CL3 and the fourth comparison optical path CL4 have a difference in the effective refractive index of light.

Then, the effective refractive index of light on the third comparison optical path CL3 is set to n_{eff3}, and the effective refractive index of light on the fourth comparison optical path CL4 is set to n_{eff4}. In this case, as shown in Equation 3, the phase difference Δϕ imparted between the light propagating through the third comparison optical path CL3 and the light propagating through the fourth comparison optical path CL4 can be calculated using Equation 5.

$$Δϕ = 2 π / λ ( ( {n}_{eff 3} \times L 3 ) - ( {n}_{eff 4} \times L 4 ) ) \qquad ( Equation 5 )$$

Here, as described above, the third comparison optical path CL3 and the fourth comparison optical path CL4 have the same path length. Therefore, Equation 5 can be replaced with Equation 6.

$$Δϕ = 2 π / λ \times L 3 ( {n}_{eff 3} - {n}_{eff 4} ) = 2 π / λ \times L 4 ( {n}_{eff 3} - {n}_{eff 4} ) \qquad ( Equation 6 )$$

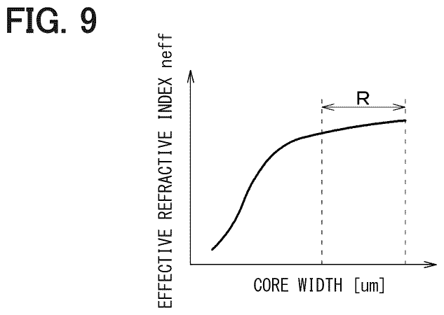

In general, as shown in FIG. 9, the increase rate of the effective refractive index of light with respect to the increase rate of the size of the optical waveguide in the width direction, that is, the third direction Dc decrease as the width of the optical waveguide in the third direction Dc increases. That is, the rate of increase in the effective refractive index of light relative to the rate of increase in the size of the optical waveguide in the third direction Dc becomes slower as the size of the optical waveguide in the third direction Dc increases.

For example, as in the first propagation portion 13, the second propagation portion 23, the third propagation portion 32, and the fourth propagation portion 42 of this embodiment, the size of the optical waveguide in the third direction Dc is set to allow that light can be propagated in the higher mode. In this case, as shown in FIG. 9, the width of the propagation portion 13, 23, 32, 42 in the third direction Dc is within the slowing region R where the rate of increase in the effective refractive index of light slows down. Therefore, it is difficult to increase the difference in the effective refractive index of light even if a difference in the effective refractive index of light is generated in the slowing region R where the rate of increase in the effective refractive index of light is slowed down. Therefore, as can be seen from Equation 6, the larger the required phase difference Δϕ, the larger the required path length of the optical waveguide. However, increasing the path length of the optical waveguide in the first direction Da increases the length of the phase adjuster 1 in the first direction Da, which is not preferable.

Furthermore, as the length of the optical waveguide in the first direction Da increases, the error in the phase difference Δϕ tends to increase due to dimensional errors caused by manufacturing errors in the first direction Da of the optical waveguide. In other words, the influence caused by manufacturing errors increases.

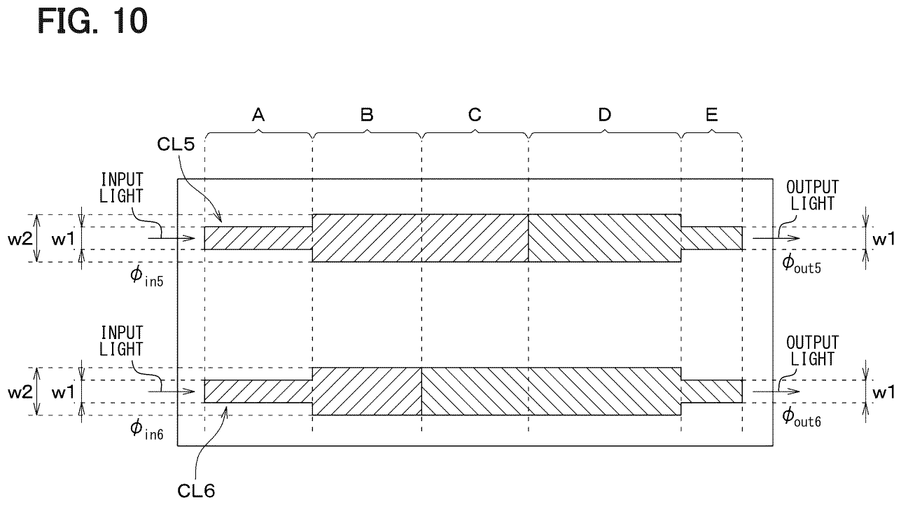

Therefore, the inventors propose a method to create a phase difference between the lights propagating through the two waveguides by using members with different refractive indexes for the two waveguides. Hereinafter, the method of imparting a phase difference between the lights will be explained using the fifth comparison optical path CL5 and the sixth comparison optical path CL6 shown in FIG. 10, which schematically shows two optical waveguides made of members having different refractive indexes for light.

The fifth comparison optical path CL5 and the sixth comparison optical path CL6 have an incidence area A into which light is incident, wide areas B to D formed with a width that slows down the rate of increase in the effective refractive index of light, and an emission area E from which light is emitted. The width w2 of the wide areas B to D is larger than the width w1 of the incidence area A and the emission area E.

The fifth comparison optical path CL5 and the sixth comparison optical path CL6 are formed of the same material in the wide area B and the wide area D, and the refractive index of light is equal to each other. In contrast, the fifth comparison optical path CL5 and the sixth comparison optical path CL6 are formed of members having different light refractive indexes in the wide area C. In FIG. 10, in order to make it easier to understand the difference between the members, different members are shown by different hatching.

The phase ϕₒᵤₜ₅ of light emitted from the fifth comparison optical path CL5 can be determined using Equation 7.

$${ϕ}_{out 5} = {ϕ}_{in 5} + {ϕ}_{A \_ 5} + {ϕ}_{B \_ 5} + {ϕ}_{C \_ 5} + {ϕ}_{D \_ 5} + {ϕ}_{E \_ 5} \qquad ( Equation 7 )$$

Here, ϕᵢₙ₅ in Equation 7 is the phase of light incident on the fifth comparison optical path CL5. Further, ϕ_{A_5}, ϕ_{B_5}, ϕ_{C_5}, ϕ_{D_5}, and ϕ_{E_5} in Equation 7 are respectively the amount of phase change when propagating through the incidence area A, the wide areas B to D, and the emission area E of the fifth comparison optical path CL5.

Further, the phase ϕₒᵤₜ₆ of light emitted from the sixth comparison optical path CL6 can be determined using Equation 8.

$${ϕ}_{out 6} = {ϕ}_{in 6} + {ϕ}_{A \_ 6} + {ϕ}_{B \_ 6} + {ϕ}_{C \_ 6} + {ϕ}_{D \_ 6} + {ϕ}_{E \_ 6} \qquad ( Equation 8 )$$

Here, ϕᵢₙ₆ in Equation 8 is the phase of light incident on the sixth comparison optical path CL6. Further, ϕ_{A_6}, ϕ_{B_6}, ϕ_{C_6}, ϕ_{D_6}, and ϕ_{E_6} in Equation 8 are respectively the amount of phase change when propagating through the incidence area A, the wide areas B to D, and the emission area E of the sixth comparison optical path CL6.

Here, in the incidence area A, the wide area B, the wide area D, and the emission area E, the fifth comparison optical path CL5 and the sixth comparison optical path CL6 are formed of the same member and have the same shape. Therefore, ϕ_{A_5} and ϕ_{A_6} are equal to each other, ϕ_{B_5} and ϕ_{B_6} are equal to each other, ϕ_{D_5} and ϕ_{D_6} are equal to each other, and ϕ_{E_5} and ϕ_{E_6} are equal to each other.

The fifth comparison optical path CL5 and the sixth comparison optical path CL6 have the same shape in the wide area C, but are formed of members having different light refractive indexes. Therefore, ϕ_{C_5} and ϕ_{C_6} are different from each other.

Therefore, the phase difference Δϕ imparted between the light propagating through the fifth comparison optical path CL5 and the light propagating through the sixth comparison optical path CL6 can be determined using Equation 9.

$$Δϕ = {ϕ}_{out 5} - {ϕ}_{out 6} = ( {ϕ}_{in 5} - {ϕ}_{in 6} ) + ( {ϕ}_{C \_ 5} - {ϕ}_{C \_ 6} ) \qquad ( Equation 9 )$$

Here, (ϕᵢₙ₅-ϕᵢₙ₆) in Equation 9 represents the phase difference between the light incident on the fifth comparison optical path CL5 and the light incident on the sixth comparison optical path CL6. Furthermore, (ϕ_{C_5}-ϕ_{C_6}) in Equation 9 indicates the phase difference of light newly applied in the wide area C, between the fifth comparison optical path CL5 and the sixth comparison optical path CL6.

In this way, by using members whose light refractive indexes are different from each other, a phase difference can be imparted to two lights propagating through two light waveguides. Therefore, in the phase adjuster 1 of this embodiment, the first optical path L1 and the second optical path L2 are respectively formed to include silicon nitride and silicon, which have different refractive indexes of light.

Next, in order to demonstrate the effects of the phase adjuster 1 of this embodiment, a comparison will be made with the comparison phase adjuster 100 shown in FIG. 7. In the comparison phase adjuster 100, as described above, the third comparison optical path CL3 and the fourth comparison optical path CL4 are formed of the same member, that is, formed of members having the same refractive index. Furthermore, in the comparison phase adjuster 100, the width Wu of the third comparison optical path CL3 is larger than the width WL of the fourth comparison optical path CL4. The third comparison optical path CL3 and the fourth comparison optical path CL4 have equal path lengths. The comparison phase adjuster 100 can provide a phase difference Δϕ that can be calculated using Equation 6 between the light propagating on the third comparison optical path CL3 and the light propagating on the fourth comparison optical path CL4.

Here, in order to compare the phase adjuster 1 of this embodiment and the comparison phase adjuster 100, the comparison phase adjuster 100 is configured to provide a phase difference of 90° between the light emitted from the third comparison optical path CL3 and the light emitted from the fourth comparison optical path CL4. In this case, when the width Wu of the third comparison optical path CL3 is 2.0 μm, which is the same as the core width of the first propagation portion 13, the second propagation portion 23, the third propagation portion 32, and the fourth propagation portion 42, the width WL of the fourth comparison optical path CL4 is 1.8 μm, which is different from 2.0 μm.

Further, when the length in the first direction Da of the third comparison optical path CL3 and the fourth comparison optical path CL4 in the first region I and the third region III is set to 20 μm, the same as the core length of the first enlarged portion 12 and the second enlarged portion 22, respectively, in order to provide a phase difference of 90° between the light emitted from the third comparison optical path CL3 and the light emitted from the fourth comparison optical path CL4, in the second region II, each of the third comparison optical path CL3 and the fourth comparison optical path CL4 has the length of 98 μm in the first direction Da.

The comparison phase adjuster 100 configured in this manner has a difference in shape in the second region II between the third comparison optical path CL3 and the fourth comparison optical path CL4 to provide a phase difference of 90° between the light emitted from the third comparison optical path CL3 and the light emitted from the fourth comparison optical path CL4. Specifically, the comparison phase adjuster 100 provides a phase difference of 90° between the light emitted from the third comparison optical path CL3 and the light emitted from the fourth comparison optical path CL4 due to the difference in effective refractive index of light, which is generated by the difference between the width Wu of the third comparison optical path CL3 and the width WL of the fourth comparison optical path CL4. In the comparison phase adjuster 100, the second region II of each of the third comparison optical path CL3 and the fourth comparison optical path CL4 is a phase adjustment portion that adds a phase difference between the light emitted from the third comparison optical path CL3 and the light emitted from the fourth comparison optical path CL4.

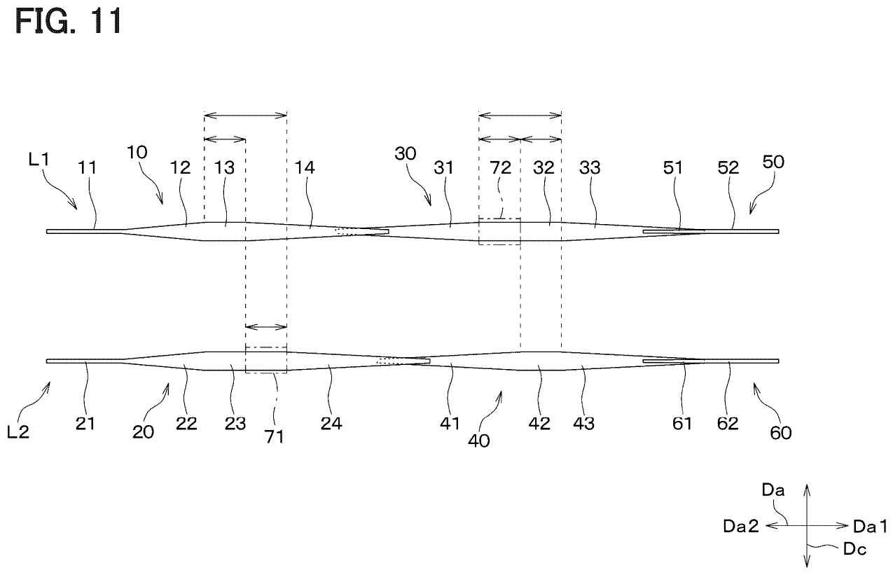

In the phase adjuster 1 of this embodiment, as shown in FIG. 11, the first incidence portion 11 of the first optical path L1 matches the second incidence portion 21 of the second optical path L2 in shape and material, and the first enlarged portion 12 of the first optical path L1 matches the second enlarged portion 22 of the second optical path L2 in shape and material. Further, in the phase adjuster 1, the first reduction portion 14 of the first optical path L1 matches the second reduction portion 24 of the second optical path L2 in shape and material, and the third enlarged portion 31 of the first optical path L1 matches the fourth enlarged portion 41 of the optical path L2 in shape and material. In the phase adjuster 1, the third reduction portion 33 of the first optical path L1 matches the fourth reduction portion 43 of the second optical path L2 in shape and material, and the fifth enlarged portion 51 of the first optical path L1 matches the sixth enlarged portion 61 of the second optical path L2 in shape and material. Further, in the phase adjuster 1, the fifth emission portion 52 of the first optical path L1 matches the sixth emission portion 62 of the optical path L2 in shape and material.

However, in the phase adjuster 1, although the first propagation portion 13 of the first optical path L1 and the second propagation portion 23 of the second optical path L2 are the same in material, their core lengths are different. Further, in the phase adjuster 1, although the third propagation portion 32 of the first optical path L1 and the fourth propagation portion 42 of the second optical path L2 are the same in material, the core lengths are different.

The phase adjuster 1 configured in this way provides a phase difference between the first light propagating through the first propagation portion 13 and the second light propagating through the second propagation portion 23 due to the difference in core length between the first propagation portion 13 of the first optical path L1 and the second propagation portion 23 of the second optical path L2. Specifically, the second propagation portion 23 whose core length is larger than that of the first propagation portion 13 has a portion whose size in the first direction Da is larger than the first propagation portion 13, so as to provide a phase difference between the first light and the second light. More specifically, a part of the second propagation portion 23 where the size in the first direction Da is larger than the first propagation portion 13 by 0.35 μm provides a phase difference between the first light and the second light. In the phase adjuster 1 of this embodiment, the part of the second propagation portion 23 where the size is larger than the first propagation portion 13 by 0.35 μm serves as a phase adjustment portion that provides a phase difference between the first light and the second light. Hereinafter, the part of the second propagation portion 23 that provides a phase difference between the first light and the second light will also be referred to as the first phase adjustment portion 71.

Further, the phase adjuster 1 provides a phase difference between the first light propagating through the third propagation portion 32 and the second light propagating through the fourth propagation portion 42 due to a difference in core length between the third propagation portion 32 of the first optical path L1 and the fourth propagation portion 42 of the second optical path L2. Specifically, a part of the third propagation portion 32 whose length in the first direction Da is larger than that of the fourth propagation portion 42 provides a phase difference between the first light and the second light. More specifically, the part of the third propagation portion 32 whose length in the first direction Da is larger than the fourth propagation portion 42 by 0.35 μm provides a phase difference between the first light and the second light. In the phase adjuster 1 of this embodiment, the part of the third propagation portion 32 larger than the fourth propagation portion 42 by 0.35 μm serves as a phase adjustment portion that provides a phase difference between the first light and the second light. Hereinafter, the part of the third propagation portion 32 that provides a phase difference between the first light and the second light will also be referred to as the second phase adjustment portion 72.

In the phase adjuster 1 of this embodiment, the first optical path L1 and the second optical path L2 have the same members and shapes except the first phase adjustment portion 71 and the second phase adjustment portion 72. The phase adjuster 1 can adjust the phase difference between the first light and the second light by adjusting the length in the first direction Da of each of the first phase adjustment portion 71 and the second phase adjustment portion 72. For example, when the length of each of the first phase adjustment portion 71 and the second phase adjustment portion 72 in the first direction Da is increased to 0.35 μm from 0.65 μm, a phase difference of 180° can be provided between the first light emitted from the first optical path L1 and the second light emitted from the second optical path L2.

Here, the first core layer 10 including the first propagation portion 13 is made of silicon nitride. Further, the fourth core layer 40 including the fourth propagation portion 42 having the same core length as the first propagation portion 13 is made of silicon, which is a different material from the material forming the first core layer 10.

The second core layer 20 including the second propagation portion 23 is made of silicon nitride. Further, the third core layer 30 including the third propagation portion 32 having the same core length as the second propagation portion 23 is made of silicon, which is a different material from the material forming the second core layer 20.

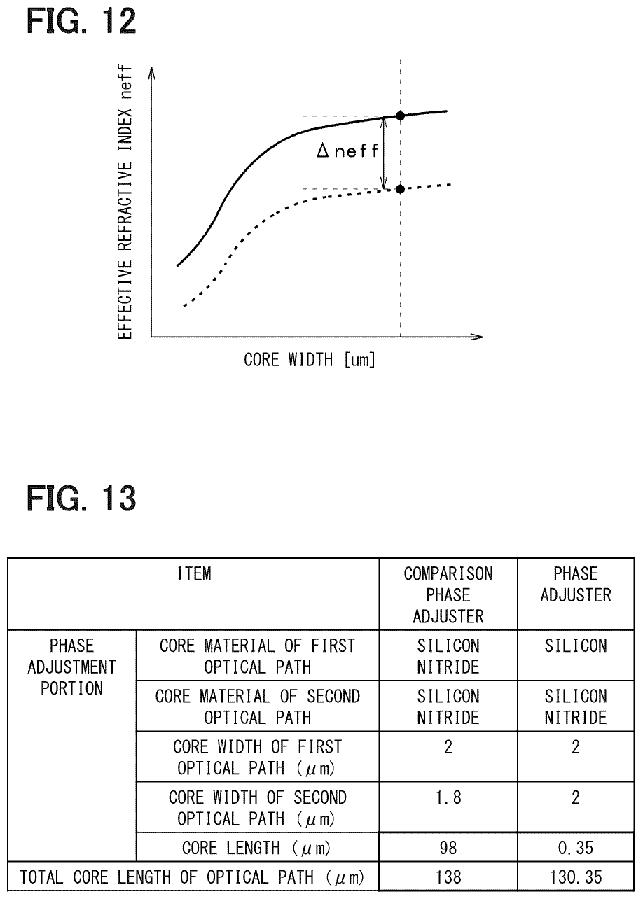

As shown in FIG. 4, silicon nitride and silicon have different optical refractive indexes under the same core width condition. Therefore, as shown in FIG. 12, an effective refractive index difference Δn_{eff} is generated between the first propagation portion 13 and the fourth propagation portion 42, which is a difference in effective refractive index between the first core layer 10 and the fourth core layer 40. Thereby, a phase difference corresponding to the effective refractive index difference Δn_{eff} can be provided between the first propagation portion 13 and the fourth propagation portion 42.

Furthermore, an effective refractive index difference Δn_{eff} occurs between the second propagation portion 23 and the third propagation portion 32, which is a difference in effective refractive index between the second core layer 20 and the third core layer 30. Thereby, a phase difference corresponding to the effective refractive index difference Δn_{eff} can be provided between the second propagation portion 23 and the third propagation portion 32.

In FIG. 12, the solid line indicates the effective light refractive index of silicon, and the broken line indicates the effective light refractive index of silicon nitride.

As described above, the material and the shape of the first optical path L1 different from the first propagation portion 13 and the third propagation portion 32 is the same as the second optical path L2 different from the second propagation portion 23 and the fourth propagation portion 42. Here, a part of the first optical path L1 different from the first propagation portion 13 and the third propagation portion 32 is referred to as a non-propagation portion in the first optical path L1, and a part of the second optical path L2 different from the second propagation portion 23 and the fourth propagation portion 42 is referred to as a non-propagation portion in the second optical path L2.

In the first optical path L1, the material and shape of the non-propagation portion in the first optical path L1 is the same as that of the non-propagation portion in the second optical path L2. Therefore, the value obtained by multiplying the length in the first direction Da of the non-propagation portion in the first optical path L1 by the effective refractive index of light is the same as the value obtained by multiplying the length in the first direction Da of the non-propagation portion in the second optical path L2 by the effective refractive index of light.

The change in phase of the first light propagating in the non-propagation portion in the first optical path L1 can be calculated according to Equation 2 by multiplying the length in the first direction Da of the non-propagation portion in the first optical path L1 by the effective refractive index of light. Further, the change in phase of the second light propagating through the non-propagation portion in the second optical path L2 can be calculated according to Equation 2 by multiplying the length in the first direction Da of the non-propagation portion in the second optical path L2 by the effective refractive index of light.

Therefore, a change in phase of the first light propagating through the non-propagation portion in the first optical path L1 having the same member and the same shape is equal to a change in phase of the second light propagating through the non-propagation portion in the second optical path L2.

FIG. 13 shows a table summarizing the core material and size of the phase adjustment portions of the phase adjuster 1 of this embodiment and the comparison phase adjuster 100. As shown in FIG. 13, the first phase adjustment portion 71 and the second phase adjustment portion 72 of the phase adjuster 1 of this embodiment is significantly smaller in the core length, compared to the second region II of the third comparison optical path CL3 and the fourth comparison optical path CL4 which is a phase adjustment portion of the comparison phase adjuster 100. Thereby, the phase adjuster 1 can make the core length of the first optical path L1 and the second optical path L2 significantly smaller than the core length of the third comparison optical path CL3 and the fourth comparison optical path CL4 of the comparison phase adjuster 100.

Further, in the phase adjuster 1 of the present embodiment, the core widths of the first phase adjustment portion 71 and the second phase adjustment portion 72 are 2.0 μm within the slowing region R where it is possible to significantly reduce the rate of increase in the effective refractive index of light relative to the rate of increase in the core width. Therefore, even if the core widths of the first phase adjustment portion 71 and the second phase adjustment portion 72 deviate from the design value due to manufacturing errors, the effective refractive index of light can be suppressed from deviating from the design value.

Further, the comparison phase adjuster 100 is configured such that the core width of the second region II of the third comparison optical path CL3 is 2.0 μm within the slowing region R, and the core width of the second region II of the fourth comparison optical path CL4 is 1.8 μm within the slowing region R. Therefore, even if the core width of the second region II of each of the third comparison optical path CL3 and the fourth comparison optical path CL4 deviates from the design value due to manufacturing error, the effective refractive index of light can be suppressed from deviating from the design value.

However, the phase difference provided by the comparison phase adjuster 100 between the light propagating in the third comparison optical path CL3 and the light propagating in the fourth comparison optical path CL4 is proportional to the core length of the second region II of each of the third comparison optical path CL3 and the fourth comparison optical path CL4, as indicated in Equation 6.

Here, the second region II of the third comparison optical path CL3 and the fourth comparison optical path CL4 of the comparison phase adjuster 100 is very large compared to the core length of the first phase adjustment portion 71 and the second phase adjustment portion 72 of the phase adjuster 1 of this embodiment. Therefore, in the comparison phase adjuster 100, if the core width of the second region II of each of the third comparison optical path CL3 and the fourth comparison optical path CL4 deviates from the designed value, the influence on the phase difference becomes large. That is, the comparison phase adjuster 100 is relatively influenced by manufacturing errors.

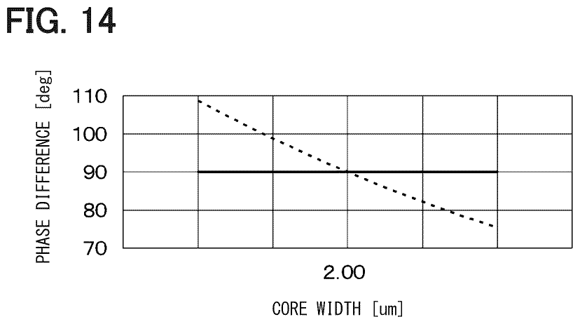

Here, FIG. 14 shows the effect on the phase difference in the phase adjuster 1 of this embodiment and the comparison phase adjuster 100, when the core width deviates from the design value due to manufacturing error. In FIG. 14, a solid line indicates a shift in phase difference due to a manufacturing error of the phase adjuster 1 of this embodiment, and a broken line indicates a shift in phase difference due to a manufacturing error of the comparison phase adjuster 100.

As shown in FIG. 14, when the core width of the second region II of the third comparison optical path CL3 of the comparison phase adjuster 100 deviates from 2.0 μm, due to manufacturing error, as the core width becomes smaller from the design value, the phase difference becomes larger from the design value of 90°. Further, as the core width of the second region II of the third comparison optical path CL3 increases from the design value, the phase difference becomes smaller from the design value of 90°.

In the phase adjuster 1 of this embodiment, when the core widths of the first phase adjustment portion 71 and the second phase adjustment portion 72 deviates from 2.0 μm due to manufacturing errors, the phase difference remains almost unchanged from the designed value of 90°. That is, the phase adjuster 1 can suppress the influence of manufacturing errors in the core widths of the first phase adjustment portion 71 and the second phase adjustment portion 72.

As described above, the phase adjuster 1 has the first optical path L1 formed to extend along the first direction Da and through which the first light propagates, and the second optical path L2 formed to extend along the first direction Da and through which the second light propagates. The first optical path L1 has the third core layer 30 formed of a material having a different refractive index for light from the second core layer 20 of the second optical path L2, and the first core layer 10 formed of a member having a different light refractive index from the fourth core layer 40 in the second optical path L2.

Accordingly, a phase difference can be provided between the first light that propagates through the first optical path L1 and the second light that propagates through the second optical path L2, due to the first core layer 10 and the fourth core layer 40, and the second core layer 20 and the third core layer 30, which are formed of members having different refractive indexes.

For this reason, it is easy to suppress the size of each of the first optical path L1 and the second optical path L2 in the first direction Da, compared with a configuration in which a phase difference is imparted between the first light propagating through the first optical path L1 and the second light propagating through the second optical path L2 due to the difference in shape between the first optical path L1 and the second optical path L2. Therefore, while suppressing the length of each of the first optical path L1 and the second optical path L2 in the first direction Da, a phase difference can be provided between the first light propagating in the first optical path L1 and the second light propagating in the second optical path L2.

According to the embodiment, it is possible to achieve the following advantageous effects.
(1) In the above embodiment, the first optical path L1 includes the first propagation portion 13 and the third propagation portion 32, which are formed of members having different refractive indexes for light. The second optical path L2 includes the second propagation portion 23 that has a different refractive index of light from the third propagation portion 32 and a different refractive index of light from the fourth propagation portion 42, and the fourth propagation portion 42 having a different refractive index for light from the first propagation portion 13.

Accordingly, it is possible to impart a phase difference between the first light and the second light based on the difference in effective refractive index between the first propagation portion 13 and the fourth propagation portion 42. In addition, a phase difference can be provided between the first light and the second light based on a difference in effective refractive index between the third propagation portion 32 and the second propagation portion 23.

Therefore, compared to the case where a phase difference is generated between the first light and the second light by forming each of the first optical path L1 and the second optical path L2 by one member, it is easy to suppress the size of the first optical path L1 and the second optical path L2 in a predetermined direction. Therefore, it is possible to easily increase the phase difference provided between the first light and the second light while suppressing the size of each of the first optical path L1 and the second optical path L2 in a predetermined direction.
(2) In the above embodiment, the first propagation portion 13 is formed of the same material as the second propagation portion 23, and has a core width the same as the core width of the second propagation portion 23, and a core length different from the core length of the second propagation portion 23. The third propagation portion 32 is formed of the same material as the fourth propagation portion 42, and has a core width the same as the core width of the fourth propagation portion 42, and a core length different from the core length of the fourth propagation portion 42.

Accordingly, a phase difference can be imparted between the first light and the second light according to the difference between the core length of the first propagation portion 13 and the core length of the second propagation portion 23, which are formed of the same material. Furthermore, a phase difference is imparted between the first light and the second light according to the difference between the core length of the third propagation portion 32 and the core length of the fourth propagation portion 42, which are formed of the same material.
(3) In the above embodiment, the core width of the first propagation portion 13 and the third propagation portion 32 is set to allow the first light to propagate in a higher-order mode. The core width of the second propagation portion 23 and the fourth propagation portion 42 is set to allow the second light to propagate in a higher-order mode.

As described above, the increase rate of the effective refractive index of light with respect to the increase rate of the core width of each of the first propagation portion 13 and the third propagation portion 32 decreases as the core width of the first propagation portion 13 and the third propagation portion 32 is increased. That is, the rate of increase in the effective refractive index of light relative to the rate of increase in the core width of each of the first propagation portion 13 and the third propagation portion 32 becomes slower as the core width of each of the first propagation portion 13 and the third propagation portion 32 increases. When the core widths of the first propagation portion 13 and the third propagation portion 32 are large enough to allow propagation in higher-order mode, the rate of increase in the effective refractive index is very small with respect to the rate of increase in the core width of the first propagation portion 13 and the third propagation portion 32.

Moreover, the increase rate of the effective refractive index of light with respect to the increase rate of the core width of each of the second propagation portion 23 and the fourth propagation portion 42 becomes smaller as the core width of the second propagation portion 23 and the fourth propagation portion 42 becomes larger. In other words, the rate of increase in the effective refractive index of light with respect to the rate of increase in size in the third direction Dc of the second propagation portion 23 and the fourth propagation portion 42 is reduced as the core width of the second propagation portion 23 and the fourth propagation portion 42 becomes larger. When the core widths of the second propagation portion 23 and the fourth propagation portion 42 are large enough to allow propagation in higher-order mode, the rate of increase in the effective refractive index is very small with respect to the rate of increase in the core width of the second propagation portion 23 and the fourth propagation portion 42.

Here, the first propagation portion 13 and the third propagation portion 32, and the second propagation portion 23 and the fourth propagation portion 42 provide a phase difference between the first light and the second light.

In this embodiment, each core width of the first propagation portion 13, the third propagation portion 32, the second propagation portion 23, and the fourth propagation portion 42 is set so that the first light and the second light propagate in higher-order mode. Accordingly, it is easy to reduce the error in the effective refractive index of light with respect to the manufacturing error with respect to the core width of each of the first propagation portion 13, the third propagation portion 32, the second propagation portion 23, and the fourth propagation portion 42. Therefore, the error in phase difference can be reduced due to manufacturing error when providing a phase difference between the first light and the second light according to the difference in core length between the first propagation portion 13 and the second propagation portion 23. In addition, the error in phase difference can be reduced due to manufacturing error when providing a phase difference between the first light and the second light according to the difference in core length between the third propagation portion 32 and the fourth propagation portion 42.
(4) In the above embodiment, the member and shape of the first optical path L1 different from the first propagation portion 13 and the third propagation portion 32 in the first optical path L1 are the same as the member and shape of the second optical path L2 different from the second propagation portion 23 and the fourth propagation portion 42.

Accordingly, the portions in the first optical path L1 and the second optical path L2 that provide a phase difference between the first light and the second light can be limited to the first propagation portion 13 and the third propagation portion 32, and the second propagation portion 23 and the fourth propagation portion 42. In other words, the portions that provides a phase difference between the first light and the second light can be the portions that can reduce the error in the phase difference between the first light and the second light due to manufacturing errors. Therefore, the influence of manufacturing errors on the phase difference between the first light and the second light provides can be further reduced by the phase adjuster 1.
(5) In the embodiment, the core length of the third propagation portion 32 is larger than the core length of the first propagation portion 13. The fourth propagation portion 42 has a core length smaller than that of the second propagation portion 23.

Accordingly, the sum of the core length of the first propagation portion 13 and the core length of the third propagation portion 32 can be brought closer to the sum of the core length of the second propagation portion 23 and the core length of the fourth propagation portion 42. Therefore, it is possible to easily bring the first optical path L1 and the second optical path L2 closer to each other in length in the first direction Da.

When the phase adjuster 1 in which the first optical path L1 and the second optical path L2 have different lengths in the first direction Da is mounted in an optical IC chip that includes an optical component different from the phase adjuster 1, the positions of the light inlet and light exit of the first optical path L1 and the second optical path L2 in the first direction Da are made to coincide with each other. In this case, if the entire optical path of the shorter path length of the first optical path L1 and the second optical path L2 is formed in a straight line, the entire optical path of the longer path cannot be formed in a straight line, and it is necessary to form the part into a curved shape. Then, when mounting an optical component different from the phase adjuster 1 into the optical IC chip, it is necessary to avoid the curved shape. In this case, it is necessary to ensure a distance between the optical path having the curved shape and the optical component, which limits the mounting position of the optical component, making it difficult to mount the optical component.

According to the phase adjuster 1 of the present embodiment in which the first optical path L1 and the second optical path L2 can be easily made close to each other in length in the first direction Da, the distance between the first optical path L1 and the optical component can be easily made close to the distance between the second optical path L2 and the optical component. Therefore, the mounting position of the optical component is less likely to be restricted, making it easier to mount the optical component.
(6) In the above embodiment, the sum of the core length of the first propagation portion 13 and the core length of the third propagation portion 32 is equivalent to the sum of the core length of the second propagation portion 23 and the core length of the fourth propagation portion 42.

Accordingly, the first optical path L1 and the second optical path L2 can be made equal in size in a predetermined direction. For this reason, when each of the first optical path L1 and the second optical path L2 is formed linearly as in the phase adjuster 1 of this embodiment, the inlet position of the light propagated to the first optical path L1 and the second optical path L2 can be matched with the exit position in the first direction Da. Then, when the phase adjuster 1 is mounted in an optical IC chip that includes an optical component different from the phase adjuster 1, it becomes easier to bring the distance between each of the first optical path L1 and the second optical path L2 and the optical component closer, such that the optical component can be more easily mounted.
(7) In the embodiment, the value obtained by multiplying the length of the non-propagation portion in the first direction Da by the effective refractive index of light in the first optical path L1 is the same as the value obtained by multiplying the length of the non-propagation portion in the first direction Da by the effective refractive index of light in the second optical path L2.

Accordingly, the amount of change in phase when the first light propagates through the non-propagation portion in the first optical path L1 can be made equal to the amount of change in phase when the second light propagates through the non-propagation portion in the second optical path L2. For this reason, the portion that provides a phase difference between the first light and the second light in the first optical path L1 and the second optical path L2 can be limited to the first propagation portion 13 and the third propagation portion 32, and the second propagation portion 23 and the fourth propagation portion 42. In other words, the part that provides a phase difference between the first light and the second light can be the part that reduces the error in the phase difference between the first light and the second light relative to manufacturing errors. Therefore, the influence of manufacturing errors on the phase difference between the first light and the second light can be reduced by the phase adjuster 1.
(8) In the embodiment, the first optical path L1 includes the first incidence portion 11 into which the first light is input, and the fifth emission portion 52 which outputs the first light. The second optical path L2 has the second incidence portion 21 into which the second light is input, and the sixth emission portion 62 which outputs the second light. The first incidence portion 11, the second incidence portion 21, the fifth emission portion 52, and the sixth emission portion 62 are formed of the same member.

Accordingly, when the input side multiplexer Mi that inputs the first light and the second light to the phase adjuster 1 is made of the same material as the output side multiplexer Mo that receives the first light and the second light from the phase adjuster 1, the phase adjuster 1 can be applied without using other member converter.
(9) In the above embodiment, the first optical path L1 and the second optical path L2 are formed of silicon and silicon nitride.

The silicon and silicon nitride have characteristics of having the slowing region R in which the rate of increase in the effective refractive index of light is significantly reduced relative to the rate of increase in the core width. Therefore, according to the present embodiment in which the first optical path L1 and the second optical path L2 are formed of silicon and silicon nitride, it is possible to reduce the influence on the effective refractive index of light due to manufacturing errors in the core widths of the first propagation portion 13 and the third propagation portion 32. In addition, it is possible to reduce the influence on the effective refractive index of light due to manufacturing errors in the core widths of the second propagation portion 23 and the fourth propagation portion 42.

### First Modification of First Embodiment

In the first embodiment, the core width of the first incidence portion 11 and the core width of the fifth emission portion 52 are smaller than the core width of the first propagation portion 13 and the third propagation portion 32, but are not limited. In the first embodiment, the core width of the second incidence portion 21 and the core width of the sixth emission portion 62 are smaller than the core width of the second propagation portion 23 and the fourth propagation portion 42, but are not limited.

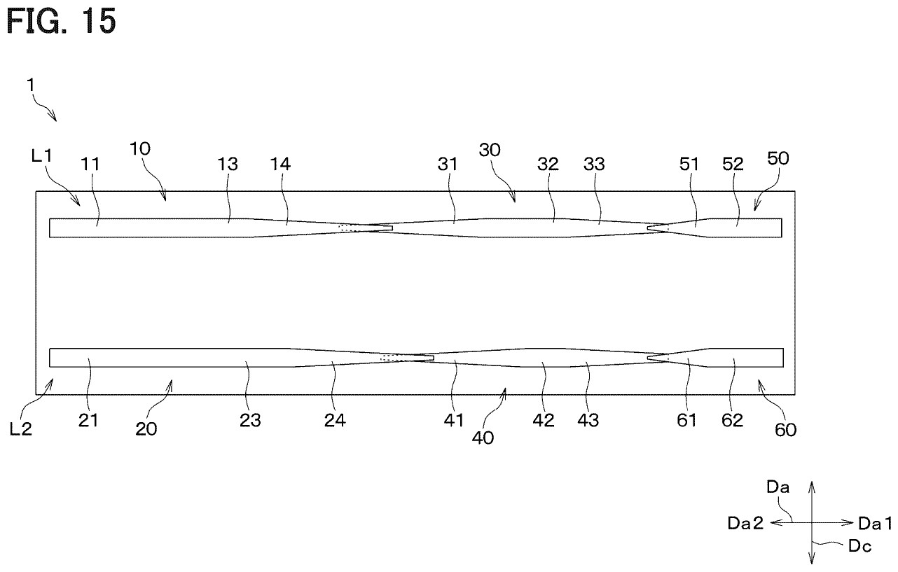

For example, as shown in FIG. 15, the first core layer 10 does not have the first enlarged portion 12, and the core width of the first incidence portion 11 is equal to the core width of the first propagation portion 13. Further, the fifth core layer 50 may be formed such that the core width of the fifth emission portion 52 is equal to the core width of the third propagation portion 32. Although not shown, the core width of the first incidence portion 11 may be larger than the core width of the first propagation portion 13, and the core width of the fifth emission portion 52 may be larger than the core width of the third propagation portion 32.

Further, as shown in FIG. 15, the second core layer 20 does not have the second enlarged portion 22, and the core width of the second incidence portion 21 is equal to the core width of the second propagation portion 23. Further, the sixth core layer 60 may be formed such that the core width of the sixth emission portion 62 is equal to the core width of the fourth propagation portion 42. Although not shown, the core width of the second incidence portion 21 may be larger than the core width of the second propagation portion 23, and the core width of the sixth emission portion 62 may be larger than the core width of the fourth propagation portion 42.

### Second Modification of First Embodiment

In the first embodiment, the core width of the first propagation portion 13 and the core width of the third propagation portion 32 are equal to each other, but are not limited to this. Further, in the first embodiment, the core width of the second propagation portion 23 and the core width of the fourth propagation portion 42 are equal to each other, but are not limited to this.

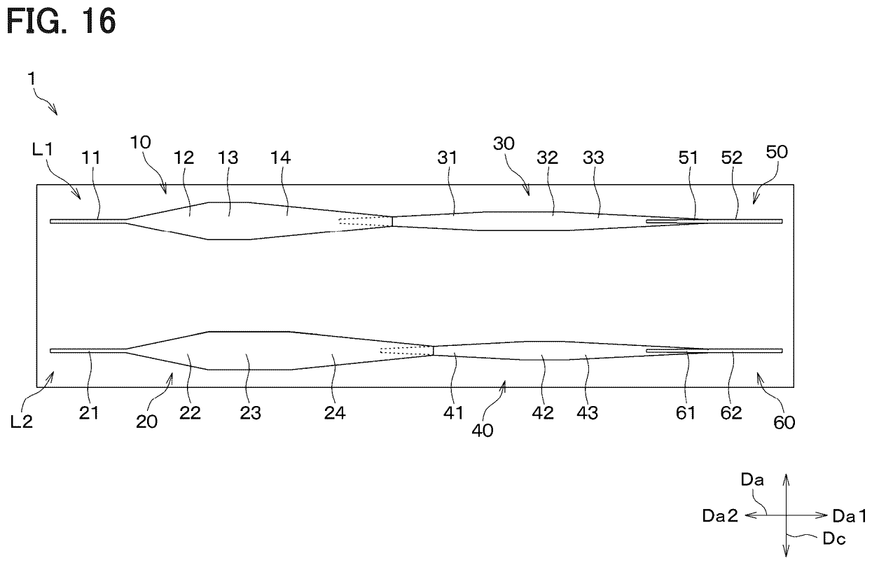

For example, as shown in FIG. 16, the core width of the first propagation portion 13 may be larger than the core width of the third propagation portion 32. Further, as shown in FIG. 16, the core width of the second propagation portion 23 may be larger than the core width of the fourth propagation portion 42.

### Third Modification of First Embodiment

In the first embodiment, the phase adjuster 1 has two optical paths, i.e., the first optical path L1 and the second optical path L2, but is not limited to this.

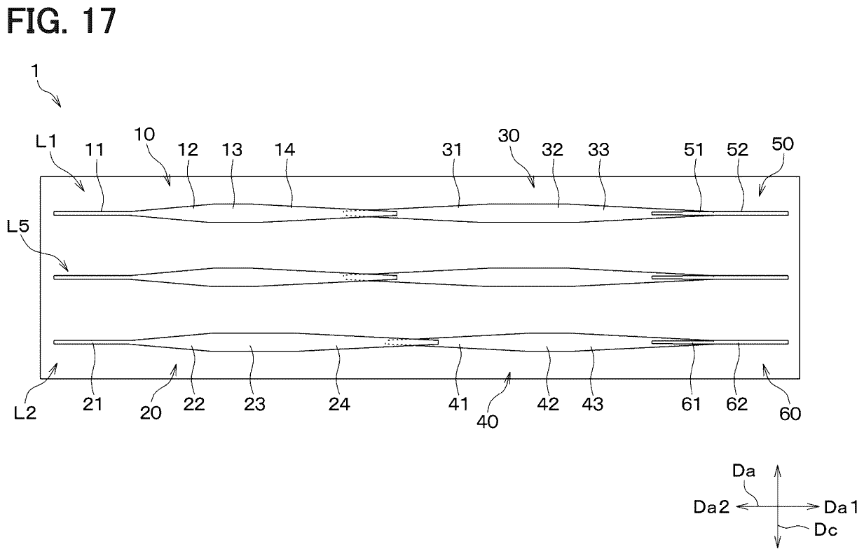

For example, as shown in FIG. 17, the phase adjuster 1 may have another optical path L5 in addition to the first optical path L1 and the second optical path L2, or may have four or more optical paths (not shown).

### Fourth Modification of First Embodiment

In the first embodiment, one phase adjustment portion is provided in each of the first optical path L1 and the second optical path L2, but is not limited to this.

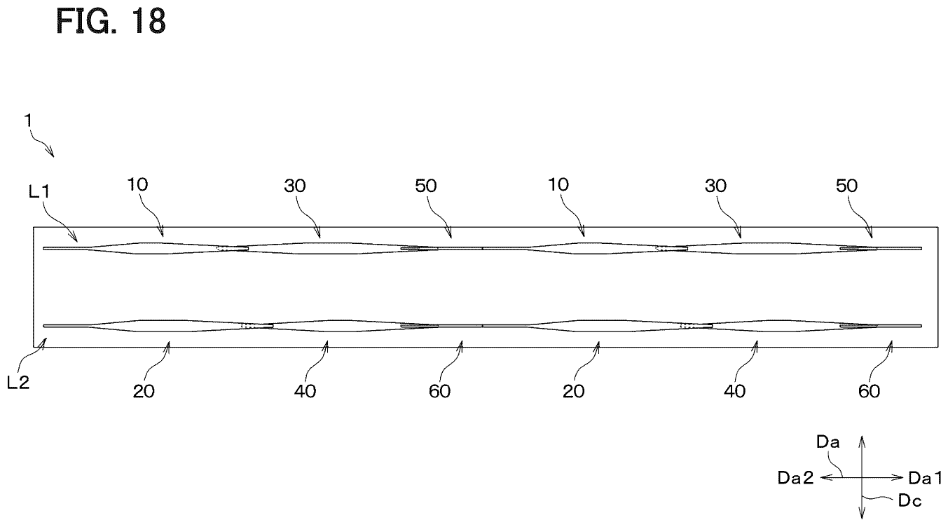

For example, as shown in FIG. 18, the first optical path L1 may be formed by two or more consecutive sets of the first core layer 10, the third core layer 30, and the fifth core layer 50 in a row. Further, the second optical path L2 may be formed by two or more sets of the second core layer 20, the fourth core layer 40, and the sixth core layer 60, although not shown. When the first optical path L1 includes two sets of the first core layer 10, the third core layer 30, and the fifth core layer 50, and the second optical path L2 includes two sets of the second core layer 20, the fourth core layer 40, and the sixth core layer 60, two phase adjustment portions are provided in each of the first optical path L1 and the second optical path L2.

### Fifth Modification of First Embodiment

In the first embodiment, the first core layer 10, the second core layer 20, the fifth core layer 50, and the sixth core layer 60 are made of silicon nitride, and the third core layer 30 and the fourth core layer 40 are made of silicon, but are not limited thereto.

For example, the first core layer 10, the second core layer 20, the fifth core layer 50, and the sixth core layer 60 may be made of silicon, and the third core layer 30 and the fourth core layer 40 may be made of silicon nitride.

### Sixth Modification of First Embodiment

In the first embodiment, the first core layer 10 to the sixth core layer 60 are formed as strip-type waveguides, but are not limited to this.

For example, the first core layer 10 to the sixth core layer 60 may be formed as a ridge-type waveguide having a convex cross-sectional shape perpendicular to the first direction Da.

### Second Embodiment

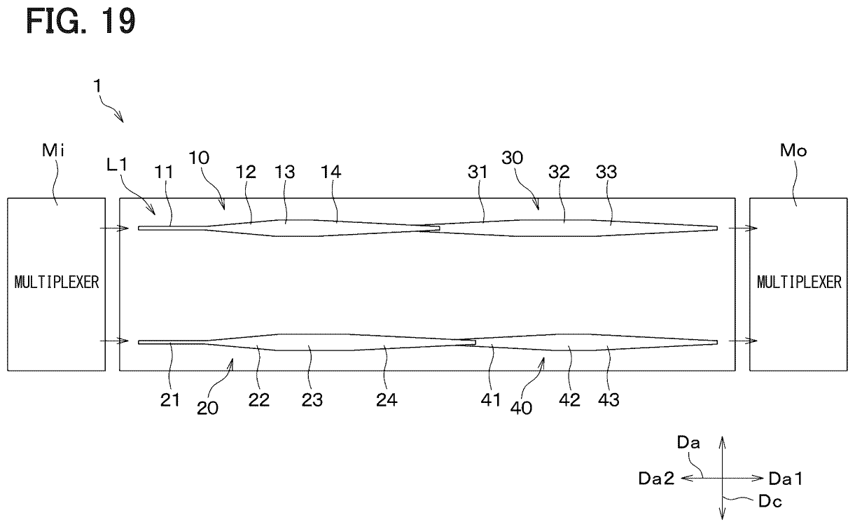

Next, a second embodiment will be described with reference to FIG. 19. In this embodiment, the configurations of the first optical path L1 and the second optical path L2 are different from the first embodiment. The other configurations are the same as those of the first embodiment. Therefore, in the present embodiment, portions different from the first embodiment will be mainly described, and description of portions similar to the first embodiment may be omitted.

As shown in FIG. 19, the first optical path L1 of this embodiment does not include the fifth core layer 50 compared to the first embodiment. In this case, the third reduction portion 33 in the third core layer 30 functions as a first output portion that guides the first light propagated from the third propagation portion 32 to the output side multiplexer Mo.

Furthermore, the second optical path L2 of this embodiment does not include the sixth core layer 60 compared to the first embodiment. In this case, the fourth reduction portion 43 in the fourth core layer 40 functions as a second output portion that guides the second light propagated from the fourth propagation portion 42 to the output side multiplexer Mo.

When the first optical path L1 and the second optical path L2 are formed in this way, the first incidence portion 11 and the second incidence portion 21 are formed of the same material, silicon nitride. Further, the third reduction portion 33 and the fourth reduction portion 43 are made of the same material, silicon. The first incidence portion 11 and the second incidence portion 21 are formed of members having different light refractive indexes from the third reduction portion 33 and fourth reduction portion 43.

The reason why the first optical path L1 and the second optical path L2 are formed in this way will be explained.

The input side multiplexer Mi to which the phase adjuster 1 of this embodiment is connected is formed of silicon nitride. The output side multiplexer Mo is formed of silicon, unlike the first embodiment. That is, multiplexers Mi and Mo formed of different members are connected to the phase adjuster 1 of this embodiment, respectively, on the input side and the output side.

Therefore, in the phase adjuster 1 of this embodiment, the first incidence portion 11 and the second incidence portion 21 can be directly connected to the input side multiplexer Mi, and the third reduction portion 33 and the fourth reduction portion 43 can be directly connected to the output side multiplexer Mo.

As described above, the first optical path L1 of this embodiment includes the first incidence portion 11 into which the first light is incident, and the third reduction portion 33 from which the first light is emitted. The second optical path L2 has the second incidence portion 21 into which the second light is input, and the second reduction portion 24 which outputs the second light. The first incidence portion 11 and the second incidence portion 21 are formed of the same member. The third reduction portion 33 and the fourth reduction portion 43 are formed of the same material, and are formed of a different material from the first incidence portion 11 and the second incidence portion 21.

Accordingly, when the input side multiplexer Mi and the output side multiplexer Mo connected to the phase adjuster 1 are formed of mutually different members, a member converter is unnecessary for connecting the phase adjuster 1 to the input side multiplexer Mi and the output side multiplexer Mo. That is, the phase adjuster 1 can also be applied as a member converter.

### Third Embodiment

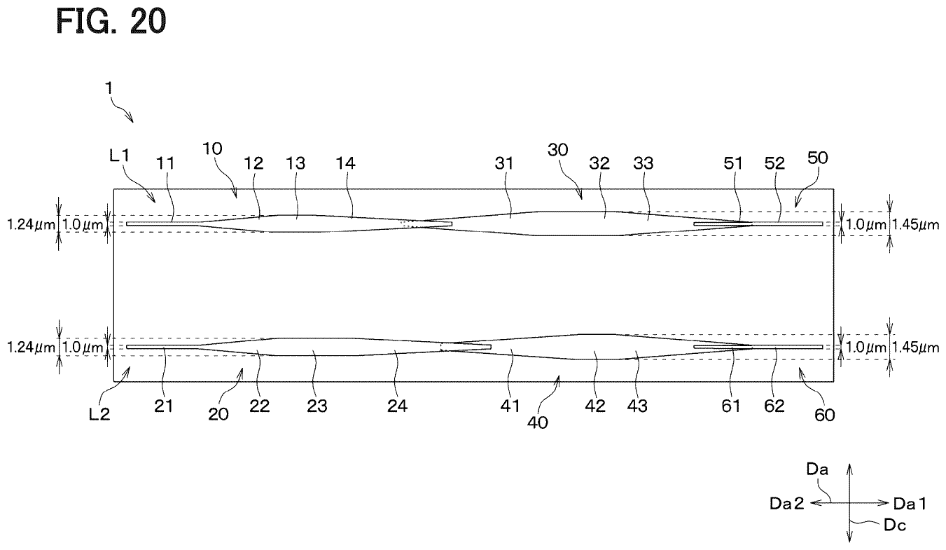

Next, a third embodiment will be described with reference to FIGS. 20 to 22. In this embodiment, the core widths of the first incidence portion 11, the first propagation portion 13, the third propagation portion 32, and the fifth emission portion 52 are different from the first embodiment. Furthermore, in this embodiment, the core widths of the second incidence portion 21, the second propagation portion 23, the fourth propagation portion 42, and the sixth emission portion 62 are different from the first embodiment. The other configurations are the same as those of the first embodiment. Therefore, in the present embodiment, portions different from the first embodiment will be mainly described, and description of portions similar to the first embodiment may be omitted.

As shown in FIG. 20, the first incidence portion 11 and the fifth emission portion 52 of this embodiment have a core width of 1.0 μm. Moreover, the core width of the first propagation portion 13 is formed to be 1.24 μm. The core width of the third propagation portion 32 is formed to be larger than the core width of the first propagation portion 13. Specifically, the core width of the third propagation portion 32 is formed to be 1.45 μm.

Further, the second incidence portion 21 and the sixth emission portion 62 of this embodiment have a core width of 1.0 μm. Further, the core width of the second propagation portion 23 is formed to be 1.24 μm. The core width of the fourth propagation portion 42 is formed to be larger than the core width of the second propagation portion 23. Specifically, the core width of the fourth propagation portion 42 is formed to be 1.45 μm.

In this way, the core width of the third propagation portion 32 is formed larger than the core width of the first propagation portion 13, and the core width of the fourth propagation portion 42 is formed larger than the core width of the second propagation portion 23.

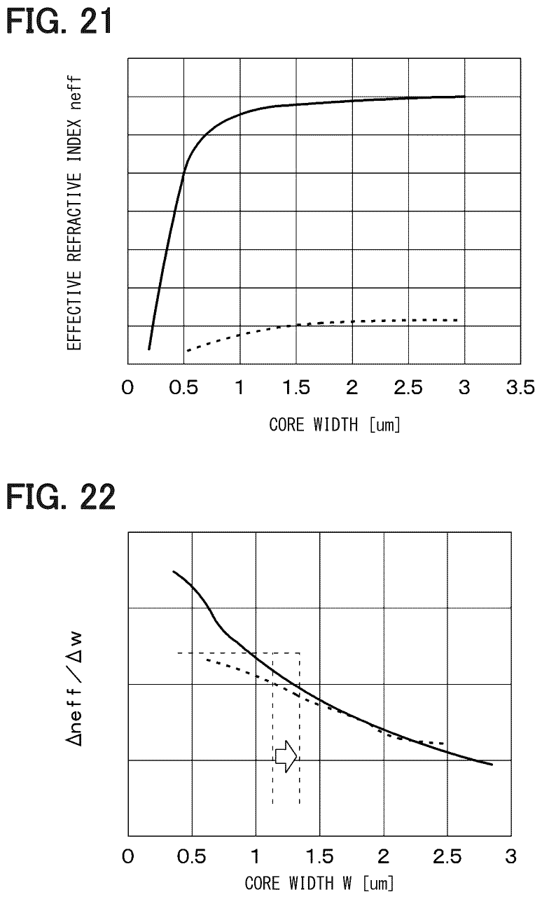

As described above, the third core layer 30 including the third propagation portion 32 and the fourth core layer 40 including the fourth propagation portion 42 are made of silicon. The first core layer 10 including the first propagation portion 13 and the second core layer 20 including the second propagation portion 23 are formed of silicon nitride. Furthermore, as shown in FIG. 21, silicon has an effective light refractive index larger than that of silicon nitride under the same core width conditions. In FIG. 21, the solid line indicates the effective light refractive index of silicon, and the broken line indicates the effective light refractive index of silicon nitride.

As described above, the rate of increase in the effective refractive index of light with respect to the rate of increase in the core width of each of the third propagation portion 32 and the fourth propagation portion 42 formed of silicon decreases as the core width of the third propagation portion 32 and the fourth propagation portion 42 is increased. Furthermore, the rate of increase in the effective refractive index of light with respect to the rate of increase in the core width of each of the first propagation portion 13 and second propagation portion 23 formed of silicon nitride decreases as the core width of the first propagation portion 13 and the second propagation portion 23 is increased.

As shown in FIGS. 21 and 22, the rate of increase in the effective refractive index of light relative to the rate of increase in the core width is greatly different between silicon nitride and silicon in some range, and almost no difference in another range. In FIG. 22, the solid line indicates the rate of increase in the effective refractive index of light with respect to the rate of increase in the core width of silicon, and the broken line indicates the rate of increase in the effective refractive index of light with respect to the rate of increase in the core width of silicon nitride.

For example, the core width of the third propagation portion 32 made of silicon is formed smaller than 1.5 μm, or the core width of the first propagation portion 13 formed of silicon nitride is formed smaller than 1.5 μm. A comparison will be made between the two cases. The rate of increase in the effective refractive index of light relative to the rate of increase in the core width of the third propagation portion 32 made of silicon is larger than that in the core width of the first propagation portion 13 made of silicon nitride. Furthermore, the rate of increase in the effective refractive index of light with respect to the rate of increase in the core width of the fourth propagation portion 42 formed of silicon is larger than that in the core width of the second propagation portion 23 formed of silicon nitride. In other words, there are regions where the rate of increase in the effective refractive index with respect to the rate of increase in the core width is significantly different, between the third propagation portion 32 and the fourth propagation portion 42 formed of silicon, and the first propagation portion 13 and the second propagation portion 23 formed of silicon nitride.

As shown in FIGS. 21 and 22, a case where the core width of the third propagation portion 32 made of silicon is equal to or larger than 1.5 μm is compared with a case where the core width of the first propagation portion 13 made of silicon nitride is equal to or larger than 1.5 μm. The rate of increase in the effective refractive index of light relative to the rate of increase in the core width of the third propagation portion 32 formed of silicon is approximately equal to that in the core width of the first propagation portion 13 formed of silicon nitride. Furthermore, the rate of increase in the effective refractive index of light with respect to the rate of increase in the core width of the fourth propagation portion 42 formed of silicon is approximately equal to that in the core width of the second propagation portion 23 formed of silicon nitride.

For this reason, the influence of design errors may be greater if the core widths of the first propagation portion 13, the second propagation portion 23, the third propagation portion 32, and the fourth propagation portion 42 are set in different areas where the rate of increase in the effective refractive index of light is significantly different relative to the rate of increase in the core width. For example, in case where the core width of each of the third propagation portion 32 and the first propagation portion 13 is set to 1.4 μm, if the core widths of the third propagation portion 32 and the first propagation portion 13 are deviated by the same manufacturing error, the deviation in effective refractive index of light will differ from each other. Further, in case where the core width of each of the fourth propagation portion 42 and the second propagation portion 23 is set to 1.4 μm, if the core widths of the fourth propagation portion 42 and the second propagation portion 23 are deviated by the same manufacturing error, the deviation in effective refractive index of light will differ from each other.

This causes an error in the phase difference between the first light emitted from the first optical path L1 and the second light emitted from the second optical path L2 in the phase adjuster 1. Therefore, when the core width is set in a region where the rate of increase in the effective refractive index of light relative to the rate of increase in the core width differs greatly depending on the member, it is desirable to adjust the core width depending on the member.

Here, the first propagation portion 13 and the second propagation portion 23 of this embodiment are set to 1.40 μm within the region where the rate of increase in the effective refractive index of light with respect to the rate of increase in core width differs greatly depending on the member. The third propagation portion 32 of this embodiment has a core width larger than that of the first propagation portion 13, and is formed to have a width of 1.45 μm. Furthermore, the fourth propagation portion 42 of this embodiment has a core width larger than that of the second propagation portion 23, and is formed to have a width of 1.45 μm.

In other words, of the first propagation portion 13 and the third propagation portion 32, the core width of the third propagation portion 32 made of silicon, which has a larger effective refractive index for light is larger than that of the first propagation portion 13 formed of silicon nitride, which has a smaller effective refractive index for light. Further, of the second propagation portion 23 and the fourth propagation portion 42, the core width of the fourth propagation portion 42 formed of silicon, which has a larger effective refractive index for light, is larger than that of the second propagation portion 23 formed of silicon nitride, which has a smaller effective refractive index for light.

As a result, as shown by the arrow in FIG. 22, the rate of increase of the effective refractive index of light with respect to the increase rate of the core width in the third propagation portion 32 can be made close to that in the first propagation portion 13. In addition, as shown by the arrow in FIG. 22, the increase rate of the effective refractive index of light with respect to the increase rate of the core width in the fourth propagation portion 42 can be made close to that in the second propagation portion 23.

Accordingly, even if the respective core widths of the third propagation portion 32 and the first propagation portion 13 deviate by the same manufacturing error, it is possible to suppress the deviation in the effective refractive index of light. Further, even if the core widths of the fourth propagation portion 42 and the second propagation portion 23 differ by the same manufacturing error, it is possible to suppress a shift in the effective refractive index of light.

Therefore, an error generated in the phase difference, due to manufacturing error, between the first light emitted from the first optical path L1 and the second light emitted from the second optical path L2 can be suppressed. That is, the influence of manufacturing errors on the phase difference between the first light and the second light can be reduced by the phase adjuster 1.

### Other Embodiments

Although the representative embodiments of the present disclosure have been described above, the present disclosure is not limited to the above-described embodiments, and can be variously modified as follows, for example:

In the embodiment, each of the first optical path L1 and the second optical path L2 is composed of a combination of a core layer formed of silicon nitride and a core layer formed of silicon, but is not limited to this.

For example, one of the first optical path L1 and the second optical path L2 may be composed only of a core layer formed of either silicon nitride or silicon. For example, the first core layer 10, the third core layer 30, and the fifth core layer 50 may all be made of silicon nitride, or may be made of silicon. The first optical path L1 may be formed by one core layer formed of either silicon nitride or silicon.

Further, the first optical path L1 and the second optical path L2 may include a core layer formed of a material different from silicon nitride and silicon. For example, the first optical path L1 and the second optical path L2 may include a core layer formed of lithium niobate (LiNbO₃). In this case, the first core layer 10 may be made of lithium niobate, the third core layer 30 may be made of silicon nitride, and the fifth core layer 50 may be made of silicon.

In the embodiment, the core width of the first propagation portion 13 and the third propagation portion 32 is set to allow the first light to propagate in a higher-order mode, but is not limited. Further, the core width of the second propagation portion 23 and the fourth propagation portion 42 is set to allow the second light to propagate in a higher-order mode, but is not limited.

For example, the core width of the first propagation portion 13 and the third propagation portion 32 may be set to allow the first light to propagate in a single mode. Further, the core width of the second propagation portion 23 and the fourth propagation portion 42 may be set to allow the second light to propagate in a single mode.

In the embodiment, the members and shapes of the parts of the first optical path L1 different from the first propagation portion 13 and the third propagation portion 32 are the same as the parts of the second optical path L2 different from the second propagation portion 23 and the fourth propagation portion 42, but not limited thereto. For example, the members and shapes of the parts of the first optical path L1 different from the first propagation portion 13 and the third propagation portion 32 may be different from the parts of the second optical path L2 different from the second propagation portion 23 and the fourth propagation portion 42.

In the embodiment, the sum of the core length of the first propagation portion 13 and the core length of the third propagation portion 32 is equal to the sum of the core length of the second propagation portion 23 and the core length of the fourth propagation portion 42, but is not limited thereto.

For example, in the above embodiment, the sum of the core length of the first propagation portion 13 and the core length of the third propagation portion 32 may be greater than or smaller than the sum of the core length of the second propagation portion 23 and the core length of the fourth propagation portion 42.

In the embodiment, the size of the first optical path L1 in the first direction Da and the size of the second optical path L2 in the first direction Da are equal to each other, but are not limited to this. For example, the size of the first optical path L1 in the first direction Da may be smaller or larger than the size of the second optical path L2 in the first direction Da.

In the embodiment, the phase adjuster 1 is arranged between the input side multiplexer Mi and the output side multiplexer Mo, but is not limited to this. For example, the phase adjuster 1 may be connected to a multi-mode interference (MMI) device.

The elements constituting the above embodiment are not necessarily essential, except for cases, such as a case where it is clearly indicated that the elements are particularly essential, and a case where it is considered that the elements are obviously essential in principle.

In the embodiment, in a case where numerical values, such as the numbers, numerical values, amounts, and ranges, of constituent elements of the embodiments are mentioned, the specific numbers are not limitative, except for cases, such as a case where it is clearly indicated that the numerical values are particularly essential, and a case where the numerical values are obviously limited to the specific numbers in principle.

In the embodiment, when the shapes, positional relationships, and the like of the constituent elements and the like are mentioned, the shapes, positional relationships, and the like are not limitative, except for cases, such as a case where it is clearly indicated, and a case where the specific shapes, positional relationships, and the like are limitative in principle.

What is claimed is:

1. A phase adjuster configured to adjust phases of a plurality of input lights, the phase adjuster comprising:
a first optical path extending along a predetermined direction to propagate a first light of the plurality of input lights; and
a second optical path opposing the first optical path and extending along the predetermined direction to propagate a second light of the plurality of input lights different from the first light, wherein
a portion of the first optical path and a portion of the second optical path are made of members having different light refractive indexes.

2. The phase adjuster according to claim 1, wherein
the first optical path includes a first waveguide and a third waveguide made of members having light refractive indexes different from each other,
the second optical path includes a second waveguide and a fourth waveguide made of members having light refractive indexes different from each other, and
the light refractive indexes of the second waveguide and the fourth waveguide are different from the light refractive index of at least one of the first waveguide and the third waveguide.

3. The phase adjuster according to claim 2, wherein
the first waveguide is made of the same member as the second waveguide,
a width of the first waveguide in an opposing direction in which the first optical path and the second optical path oppose to each other is the same as a width of the second waveguide in the opposing direction,
a length of the first waveguide in the predetermined direction is different from that of the second waveguide,
the third waveguide is made of the same member as the fourth waveguide,
a width of the third waveguide in the opposing direction is the same as a width of the fourth waveguide in the opposing direction, and
a length of the third waveguide in the predetermined direction is different from that of the fourth waveguide.

4. The phase adjuster according to claim 3, wherein
the width of the first waveguide and the third waveguide in the opposing direction is set to allow the first light to propagate in a higher order mode, and
the width of the second waveguide and the fourth waveguide in the opposing direction is set to allow the second light to propagate in a higher order mode.

5. The phase adjuster according to claim 4, wherein
a part of the first optical path different from the first waveguide and the third waveguide is made of a material that is the same as a part of the second optical path different from the second waveguide and the fourth waveguide, and
the part of the first optical path different from the first waveguide and the third waveguide has the same shape as the part of the second optical path different from the second waveguide and the fourth waveguide.

6. The phase adjuster according to claim 5, wherein
a length of the first waveguide in the predetermined direction is larger than a length of the second waveguide in the predetermined direction, and
a length of the third waveguide in the predetermined direction is smaller than a length of the fourth waveguide in the predetermined direction.

7. The phase adjuster according to claim 6, wherein
a sum of the length of the first waveguide in the predetermined direction and the length of the third waveguide in the predetermined direction is equal to a sum of the length of the second waveguide in the predetermined direction and the length of the fourth waveguide in the predetermined direction.

8. The phase adjuster according to claim 4, wherein
a value obtained by multiplying a length of a portion of the first optical path different from the first waveguide and the third waveguide in the predetermined direction by an effective refractive index of light is the same as a value obtained by multiplying a length of a portion of the second optical path different from the second waveguide and the fourth waveguide in the predetermined direction by an effective refractive index of light.

9. The phase adjuster according to claim 4, wherein
one of the first waveguide and the third waveguide has a light refractive index larger than that of the other of the first waveguide and the third waveguide,
the one of the first waveguide and the third waveguide has a rate of increase in light refractive index relative to a rate of increase in width in the opposing direction, which is set to approach that of the other of the first waveguide and the third waveguide,
one of the second waveguide and the fourth waveguide has a light refractive index larger than that of the other of the second waveguide and the fourth waveguide, and
the one of the second waveguide and the fourth waveguide has a rate of increase in light refractive index relative to a rate of increase in width in the opposing direction, which is set to approach that of the other of the second waveguide and the fourth waveguide.

10. The phase adjuster according to claim 9, wherein
a width of the one of the first waveguide and the third waveguide in the opposing direction is larger than that of the other of the first waveguide and the third waveguide in the opposing direction, and
a width of the one of the second waveguide and the fourth waveguide in the opposing direction is larger than that of the other of the second waveguide and the fourth waveguide in the opposing direction.

11. The phase adjuster according to claim 1, wherein
the first optical path has a first input portion into which the first light is input, and a first output portion which outputs the first light,
the second optical path has a second input portion into which the second light is input, and a second output portion which outputs the second light, and
the first input portion, the second input portion, the first output portion, and the second output portion are made of the same member.

12. The phase adjuster according to claim 1, wherein
the first optical path has a first input portion into which the first light is input, and a first output portion which outputs the first light,
the second optical path has a second input portion into which the second light is input, and a second output portion which outputs the second light,
the first input portion and the second input portion are made of the same member, and
the first output portion and the second output portion are made of the same member, which is different from the first input portion and the second input portion.

13. The phase adjuster according to claim 1, wherein the first optical path and the second optical path are made of any one of silicon, silicon nitride, and lithium niobate.
